(19) United States
(12) Patent Application Publication
(10) Pub. No.: US 2014/0161971 A1
(43) Pub. Date: Jun. 12, 2014

(54) CONDUCTIVE PATTERN, METHOD FOR FORMING THE SAME, PRINTED WIRING BOARD, AND MANUFACTURING METHOD OF THE SAME

(71) Applicant: FUJIFILM CORPORATION, Tokyo (JP)

(72) Inventor: Seishi KASAI, Ashigarakami-gun (JP)

(73) Assignee: FUJIFILM CORPORATION, Tokyo (JP)

(21) Appl. No.: 14/183,379

(22) Filed: Feb. 18, 2014

Related U.S. Application Data
(63) Continuation of application No. PCT/JP2012/071246, filed on Aug. 16, 2012.

(30) Foreign Application Priority Data
Aug. 19, 2011 (JP) 2011-179845
Aug. 19, 2011 (JP) 2011-179998

(51) Int. Cl. C09D 11/00

(52) U.S. Cl. CPC C09D 11/52
USPC 427/123

(57) ABSTRACT

A forming method of a conductive pattern including a base material and a pattern of a composition gradient layer in which the composition continuously changes from a metal to a resin in a thickness direction from the farthest side to the base material toward the nearest side to the base material, includes: ejecting at least two kinds of ink compositions of an ink composition containing a metal and an ink composition containing a compound capable of being cured with active energy ray, or a polymer or oligomer, onto the base material by an inkjet method to fabricate the composition gradient layer.

### CROSS REFERENCE TO RELATED APPLICATION

This is a continuation of International Application No. PCT/JP2012/071246 filed on Aug. 16, 2012, and claims priority from Japanese Patent Application No. 2011-179845 filed on Aug. 19, 2011 and Japanese Patent Application No. 2011-179998 filed on Aug. 19, 2011, the entire disclosures of which are incorporated herein by reference.

### TECHNICAL FIELD

The present invention relates to a forming method of a conductive pattern adopting a technology of an inkjet system, which is excellent in adaptability to manufacture and high in adhesion and conductivity and in which an image-formed conductive pattern does not change before drying, a manufacturing method of a printed wiring board adopting the forming method, and a printed wiring board manufactured by the manufacturing method.

### BACKGROUND ART

As materials for constituting electrical members, metal materials such as gold, silver, copper, platinum, aluminum, palladium, and nickel have been utilized from old. Above all, since copper or silver materials are a material which is low in prices, high in versatility, and good in electrical conductivity, these materials are widely used even now as a material for securing electrical continuity, such as circuit forming members of printed wiring boards, various electrical contact members, and external electrode members, e.g., capacitors, etc.

On the other hand, in recent years, miniaturization and thinning of electronic devices such as flexible displays are being advanced.

Miniaturization and thinning of members which are applied to such devices are also even more demanded. For example, attention is paid to the matter that a conductive material such as metals is subjected to patterning by means of printing, thereby forming a wiring directly on a flexible base material (for example, resins, etc.). According to this, continuous roll-to-roll production becomes possible; drastic productivity improvement and cost reduction are realized; patterning becomes possible on other surfaces than the smooth surface; and it becomes possible to arbitrarily print a variable pattern. Thus, it may be considered that a degree of freedom of design increases; and that the production is realized from an extremely small amount.

As methods of achieving the foregoing patterning by means of printing, Japanese Patent No. 4414145 proposes a metal nanoparticle dispersion which can be subjected to low-temperature layer formation and which is adaptable to various printing applications.

In addition, Japanese Patent No. 4242176 proposes a surface-protected metal nanoparticle dispersion, which is aimed to prevent a lowering of performances of printed substrates formed with a copper paste, or the like by means of aggregation of copper particles.

Furthermore, JP-A-2004-247667 proposes a method for forming a conductive pattern by preparing an inkjet ink containing a metal nanoparticle (mainly, silver or copper), charging the inkjet ink into in a printer, and applying printing directly on the base material surface.

### SUMMARY OF INVENTION

However, in the case where a metal is subjected to patterning on a flexible substrate that is an organic material (for example, resins, etc.), it is difficult to impart sufficient adhesion, and this matter is a big wall in practical use. Furthermore, an ink is hardly absorbed on the substrate, an image-formed pattern changes until drying of an ink solvent, and jaggy (strain such as jagged outlines of the pattern) or bulge (liquid pool) occurs. For those reasons, there are involved such problems that patterns are fused each other; and that line image formation cannot be achieved.

In view of the foregoing circumstances, the invention has been made, and an object thereof is to provide a forming method of a conductive pattern, which is excellent in adaptability to manufacture and high in adhesion and conductivity and in which an image-formed conductive pattern does not change before drying, a manufacturing method of a printed wiring board adopting the forming method, and a printed wiring board manufactured by the manufacturing method.

The problems of the invention have been attained by the following measures.

[1] A forming method of a conductive pattern including a base material and a pattern of a composition gradient layer in which the composition continuously changes from a metal to a resin in a thickness direction from the farthest side to the base material toward the nearest side to the base material, which comprises

ejecting at least two kinds of ink compositions of an ink composition containing a metal and an ink composition containing a compound capable of being cured with active energy ray, or a polymer or oligomer, onto the base material by an inkjet method, thereby fabricating the composition gradient layer.

[2] The forming method of a conductive pattern as set forth above in [1], wherein

at least an ink composition containing a metal and an ink composition containing a compound capable of being cured with active energy ray are used as the at least two kinds of ink compositions, and

the inkjet method uses at least a first inkjet head and a second inkjet head, and wherein the method includes

a step of supplying a first ink containing the ink composition containing a metal into the first inkjet head,

a step of supplying a second ink containing the ink composition containing a compound capable of being cured with active energy ray into the second inkjet head,

a control step of determining a ratio of an amount of the first ink ejected from the first inkjet head to an amount of the second ink ejected from the second inkjet head,

a forming step of ejecting the first ink or the second ink from at least one of the first inkjet head and the second inkjet head according to the determined ratio, thereby forming one layer, and

a laminating step of repeating the forming step to laminate a plurality of the layers on the base material, thereby obtaining the composition gradient layer, wherein

in the control step, the ratio is determined such that a ratio of the first ink becomes large, whereas a ratio of the second ink becomes small, in a thickness direction of the plural layers from the near side to the base material toward the far side to the base material.

[3] The forming method of a conductive pattern as set forth above in [2], wherein the second ink contains a compound having an unsaturated double bond, as the compound capable of being cured with active energy ray, and a polymerization initiator.
[4] The forming method of a conductive pattern as set forth above in [3], wherein the compound having the unsaturated double bond is an N-vinyl lactam.
[5] The forming method of a conductive pattern as set forth above in [4], wherein the N-vinyl lactam is N-vinyl caprolactam.
[6] The forming method of a conductive pattern as set forth above in any one of [2] to [5], wherein in the forming step, an ink amount of droplets ejected from the first and second inkjet heads is from 0.3 to 100 pL.
[7] The forming method of a conductive pattern as set forth above in any one of [2] to [6], wherein in the forming step, a droplet size of droplets ejected from the first and second inkjet heads is from 1 to 300 μm.
[8] The forming method of a conductive pattern as set forth above in [1], wherein

at least an ink composition containing a metal and an ink composition containing a compound capable of being cured with active energy ray are used as the at least two kinds of ink compositions, and

the inkjet method uses a plurality of inkjet heads, and wherein the method includes

a step of supplying a plurality of mixed inks which are a mixture of a first ink containing the ink composition containing a metal and a second ink containing the ink composition containing a compound capable of being cured with active energy ray, and which are different in a mixing ratio from each other, into the plurality of inkjet heads, respectively,

a selecting step of successively selecting one inkjet head from the plurality of inkjet heads in decreasing order of a ratio of the second ink contained in the mixed ink supplied into the inkjet head,

a forming step of ejecting the mixed ink from the selected inkjet head, thereby forming one layer, and

a laminating step of repeating the forming step to laminate a plurality of the layers on the base material, thereby obtaining the composition gradient layer.

[9] The forming method of a conductive pattern as set forth above in [8], wherein the second ink contains a compound having an unsaturated double bond, as the compound capable of being cured with active energy ray, and a polymerization initiator.
[10] The forming method of a conductive pattern as set forth above in [9], wherein the compound having the unsaturated double bond is an N-vinyl lactam.
[11] The forming method of a conductive pattern as set forth above in [10], wherein the N-vinyl lactam is N-vinyl caprolactam.
[12] The forming method of a conductive pattern as set forth above in any one of [8] to [11], wherein in the forming step, an ink amount of droplets ejected from the first and second inkjet heads is from 0.5 to 150 pL.
[13] The forming method of a conductive pattern as set forth above in any one of [8] to [12], wherein in the forming step, a droplet size of droplets ejected from the first and second inkjet heads is from 2 to 450
[14] The forming method of a conductive pattern as set forth above in [1], wherein

at least an ink composition containing a metal and an ink composition containing a polymer or oligomer are used as the at least two kinds of ink compositions, and

the inkjet method uses at least a first inkjet head and a second inkjet head, and wherein the method includes

a step of supplying a first ink containing the ink composition containing a metal into the first inkjet head,

a step of supplying a second ink containing the ink composition containing a polymer or oligomer into the second inkjet head,

a control step of determining a ratio of an amount of the first ink ejected from the first inkjet head to an amount of the second ink ejected from the second inkjet head,

a forming step of ejecting the first ink or the second ink from at least one of the first inkjet head and the second inkjet head according to the determined ratio, thereby forming one layer, and

a laminating step of repeating the forming step to laminate a plurality of the layers on the base material, thereby obtaining the composition gradient layer, wherein

in the control step, the ratio is determined such that a ratio of the first ink becomes large, whereas a ratio of the second ink becomes small, in a thickness direction of the plural layers from the near side to the base material toward the far side to the base material.

[15] The forming method of a conductive pattern as set forth above in [14], wherein the polymer or oligomer is a urethane polymer or oligomer.
[16] The forming method of a conductive pattern as set forth above in [15], wherein the urethane polymer or oligomer has a repeating unit represented by the following general formula (1):

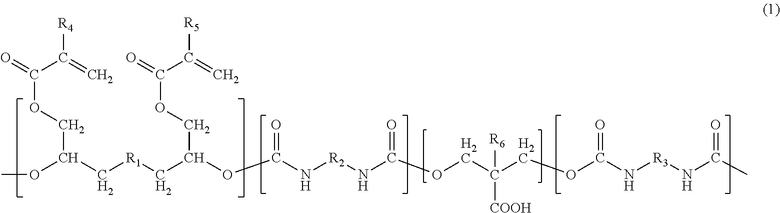

In the foregoing general formula, each of R₁ to R₃ independently represents an alkylene group, an arylene group, or a biarylene group; and each of R₄ to R₆ independently represents a hydrogen atom, an alkyl group, an aryl group, or a heteroaryl group.

[17] The forming method of a conductive pattern as set forth above in any one of [14] to [16], wherein the base material is a base material made of a synthetic resin.
[18] The forming method of a conductive pattern as set forth above in any one of [14] to [17], wherein in the forming step, an ink amount of droplets ejected from the first and second inkjet heads is from 0.3 to 100 pL.
[19] The forming method of a conductive pattern as set forth above in any one of [14] to [18], wherein in the forming step, a droplet size of droplets ejected from the first and second inkjet heads is from 1 to 300 μm.
[20] The forming method of a conductive pattern as set forth above in [1], wherein

at least an ink composition containing a metal and an ink composition containing a polymer or oligomer are used as the at least two kinds of ink compositions, and

the inkjet method uses a plurality of inkjet heads, and wherein the method includes

a step of supplying a plurality of mixed inks which are a mixture of a first ink containing the ink composition containing a metal and a second ink containing the ink composition containing a polymer or oligomer, and which are different in a mixing ratio from each other, into the plurality of inkjet heads, respectively,

a selecting step of successively selecting one inkjet head from the plurality of inkjet heads in decreasing order of a ratio of the second ink contained in the mixed ink supplied into the inkjet head,

a forming step of ejecting the mixed ink from the selected inkjet head, thereby forming one layer, and

a laminating step of repeating the forming step to laminate a plurality of the layers on the base material, thereby obtaining the composition gradient layer.

[21] The forming method of a conductive pattern as set forth above in [20], wherein the polymer or oligomer is a urethane polymer or oligomer.
[22] The forming method of a conductive pattern as set forth above in [21], wherein the urethane polymer or oligomer has a repeating unit represented by the following general formula (1):

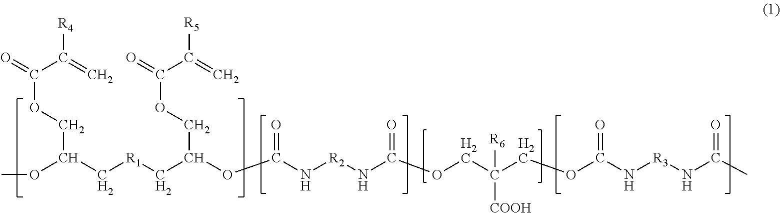

In the foregoing general formula, each of R₁ to R₃ independently represents an alkylene group, an arylene group, or a biarylene group; and each of R₄ to R₆ independently represents a hydrogen atom, an alkyl group, an aryl group, or a heteroaryl group.

[23] The forming method of a conductive pattern as set forth above in any one of [20] to [22], wherein the base material is a base material made of a synthetic resin.
[24] The forming method of a conductive pattern as set forth above in any one of [20] to [23], wherein in the forming step, an ink amount of droplets ejected from the first and second inkjet heads is from 0.5 to 150 pL.
[25] The forming method of a conductive pattern as set forth above in any one of [20] to [24], wherein in the forming step, a droplet size of droplets ejected from the first and second inkjet heads is from 2 to 450 μm.
[26] The forming method of a conductive pattern as set forth above in any one of [1] and [14] to [25], wherein the ink composition containing the polymer or oligomer further contains a solvent having a boiling point of from 60° C. to 300° C.
[27] The forming method of a conductive pattern as set forth above in any one of [1] to [26], wherein the metal is a particle having an average particle size of from 5 to 1,000 nm.
[28] The forming method of a conductive pattern as set forth above in any one of [1] to [27], wherein the metal is a particle containing at least one member selected from the group consisting of gold, silver, copper, platinum, aluminum, palladium, and nickel, or a particle of an alloy containing two or more metals selected from the foregoing group.
[29] A manufacturing method of a printed wiring board, comprising using the forming method of a conductive pattern as set forth above in any one of [1] to [28].
[30] A printed wiring board, manufactured by the manufacturing method as set forth above in [29].

According to the invention, a forming method of a conductive pattern, which is excellent in adaptability to manufacture and high in adhesion and conductivity and in which a drawn conductive pattern does not change before drying, a manufacturing method of a printed wiring board adopting the forming method, and a printed wiring board manufactured by the manufacturing method can be provided.

### BRIEF DESCRIPTION OF DRAWING

FIG. 1 is a schematic view of a conductive pattern including a composition gradient layer.

FIG. 2 is a schematic view of a conductive pattern including a composition gradient layer.

FIG. 3 is an overall configuration view of a composition gradient layer fabrication apparatus.

FIG. 4 is a diagrammatic view of an image formation section of a composition gradient layer fabrication apparatus.

FIGS. 5A, 5B, 5C, 5D and 5E are each a view for explaining the formation of a composition gradient layer by an image formation mixing method.

FIGS. 6A, 6B and 6C are each a view for explaining other embodiment of an image formation mixing method.

FIG. 7 is an overall configuration view of a composition gradient layer fabrication apparatus according to an embodiment of an ink mixing method.

FIGS. 8A, 8B and 8C are each a view for explaining the formation of a composition gradient layer by an ink mixing method.

FIGS. 9A, 9B, 9C and 9D are each a view for explaining deposition positions of respective inks in an image formation mixing method.

### DESCRIPTION OF EMBODIMENTS

The invention is concerned with a forming method of a conductive pattern including a base material and a pattern of a composition gradient layer in which the composition continuously changes from a metal to a resin in a thickness direction from the farthest side to the base material toward the nearest side to the base material, which comprises

ejecting at least two kinds of ink compositions of an ink composition containing a metal and an ink composition containing a compound capable of being cured with active energy ray (hereinafter also referred to as “curable compound”), or a polymer or oligomer, onto the base material by an inkjet method, thereby fabricating the composition gradient layer.

### [Composition Gradient Layer]

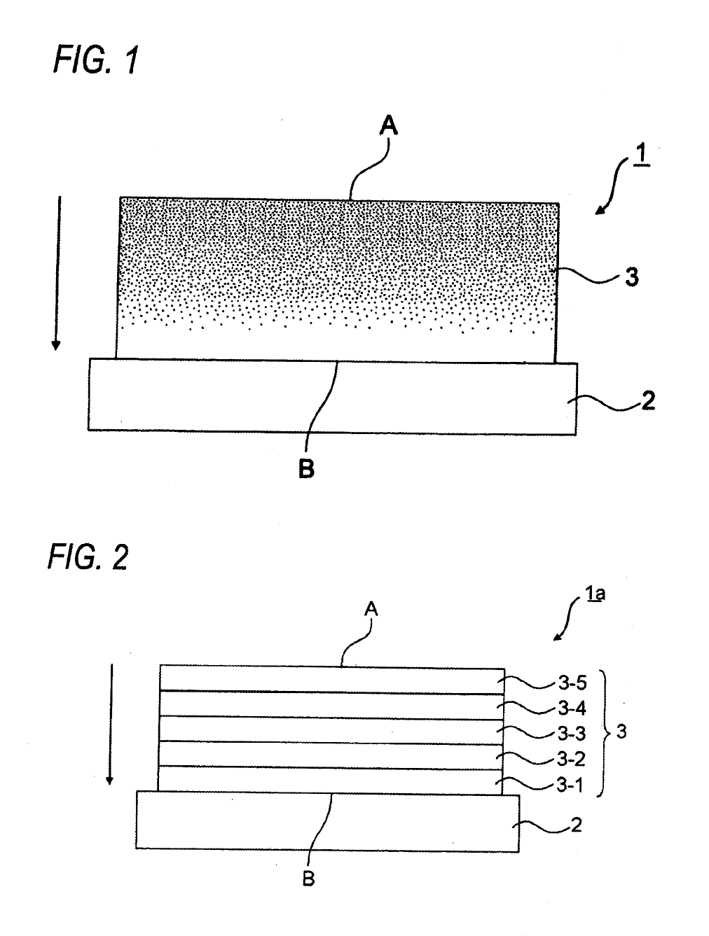

FIG. 1 schematically shows a cross section of a composition gradient layer of a conductive pattern formed by the method according to the invention.

A conductive pattern 1 according to the invention includes a pattern composed of a composition gradient layer 3 on a base material 2. In the composition gradient layer 3, the composition continuously changes from a metal to a resin in a thickness direction from a farthest side A to the base material 2 toward a nearest side B to the base material 2 (namely, in a direction of an arrow in FIG. 1).

The “thickness direction” as referred to herein means a “layer thickness direction” of the composition gradient layer 3. In addition, it is meant by the terms “composition continuously changes from a metal to a resin in a thickness direction” that when the composition gradient layer is divided into every region of a certain thickness (for example, from 0.1 to 5 μm) in the thickness direction, and a proportion of a mass of the resin occupied in each region relative to a total mass of the resin and the metal (hereinafter referred to as “resin content”) is taken, a difference in the resin content between adjacent regions is not more than 50%, and more preferably not more than 30%. When the difference in the resin content between adjacent regions is large than 50%, the change in the resin content becomes step-by-step, so that it may be impossible to obtain high adhesion and conductivity. Incidentally, the difference in the resin content between certain two adjacent regions may be 0%.

From the viewpoint of obtaining high conductivity, the resin content on the farthest side A to the base material of the composition gradient layer 3 (for example, the resin content in a region of from 0.1 to 5 μm in the thickness from A) is preferably from 0 to 50%, more preferably from 0 to 30%, and still more preferably substantially 0% (from 0 to 0.2%). In addition, from the viewpoint of obtaining high adhesion, the resin content on the nearest side B to the base material of the composition gradient layer 3 (for example, the resin content in a region of from 0.1 to 5 μm in the thickness from B) is preferably from 50 to 100%, more preferably from 70 to 100%, and still more preferably substantially 100% (from 99 to 100%).

The resin content in each region can be determined by, for example, a depth direction profile of XPS.

Though a configuration of the composition gradient layer 3 is not particularly limited so far as the resin content continuously changes as described above, a configuration shown in FIG. 2, in which a plurality of layers having a different resin content from each other are laminated, is exemplified as a preferred configuration.

A conductive layer 1a shown in FIG. 2 includes the composition gradient layer 3 on the base material 2, and the composition gradient layer 3 includes a plurality of layers 3-1, 3-2, 3-3, 3-4 and 3-5 having a different resin content from each other. In the layers 3-1, 3-2, 3-3, 3-4 and 3-5, the resin content becomes large continuously within the range of from 0% to 100% from the layer 3-5 on the farthest side A to the base material 2 toward the layer 3-1 the nearest side B to the base material 2 (i.e., in the direction of an arrow in FIG. 2).

From the standpoint of obtaining good adhesion and conductivity, among the layers 3-1, 3-2, 3-3, 3-4 and 3-5, a difference in the resin content between adjacent two layers is not more than 50%, and preferably not more than 30%. In addition, the resin content of the layer 3-5 on the farthest side A to the base material 2 is preferably from 0% to 20%, and more preferably from 0% to 15%. The resin content of the layer 3-1 on the nearest side B to the base material 2 is preferably from 80% to 100%, and more preferably from 85% to 100%.

In FIG. 2, five layers of the layers 3-1, 3-2, 3-3, 3-4 and 3-5 are laminated to form the composition gradient layer 3; however, a number of layers to be laminated is not particularly limited. The layer number is preferably from 3 to 10 layers, and more preferably from 3 to 7 layers. In addition, a thickness of each layer is preferably from 0.1 μm to 5 μm, and more preferably from 0.3 μm to 3 μm. It is preferable that the thickness of each layer is substantially identical (an error in the thickness falls within the range of ±0.5 μm).

Incidentally, in the case where an interface between the layers is not definite, a resin obtained by dividing the composition gradient layer 3 into a thickness of from 0.1 μm to 5 μm in the thickness direction may be considered as “layer”.

The resin content in each region can be determined by, for example, a depth direction profile of XPS.

### (Layer Thickness)

A thickness of the composition gradient layer in the invention is preferably 1 μm or more, more preferably from 1 m to 20 μm, and still more preferably from 3 μm to 10 μm. So far as the layer thickness of the composition gradient layer falls within this range, a conductive pattern with good conductivity can be obtained. In addition, this range is also a preferred range from the viewpoint of not impairing performance and commercial value of a device obtained by using the subject conductive pattern, or the like.

In the invention, the composition gradient layer is fabricated by ejecting at least two kinds of ink compositions of an ink composition containing a metal and an ink composition containing a curable compound or a polymer or oligomer onto the base material by an inkjet method.

The inks which are used in the invention are hereunder described.

### (Ink Composition)

The ink composition which is used in the invention is roughly classified into an ink composition containing a metal and an ink composition containing a curable compound or a polymer or oligomer. The ink composition may contain, in addition to the metal and the curable compound or the polymer or oligomer, a solvent, a binder component, and other additives.

The ink composition may be used solely as an ink, or two or more kinds of ink compositions may be mixed and used as an ink.

### (Ink)

As the ink which is used in the invention, an ink containing an ink composition containing a metal and an ink containing an ink composition containing a curable compound or a polymer or oligomer may be each independently used as two or more kinds of inks, or a mixture of an ink containing an ink composition containing a metal and an ink containing an ink composition containing a curable compound or a polymer or oligomer may be used as a mixed ink.

The ink may contain, in addition to the metal and the curable compound or the polymer or oligomer, a solvent, a binder component, and other additives.

### (Metal)

Though the metal which can be used in the invention is not particularly limited so far as it has conductivity, for example, gold, silver, copper, platinum, aluminum, palladium, nickel, ruthenium, rhodium, osmium, iridium, and mixtures or alloys thereof can be used. It is preferable to use gold, silver, copper, platinum, aluminum, palladium, nickel, or a mixture or alloy thereof. From the standpoints of low prices, high versatility, and good electrical conductivity, it is more preferable to use copper or silver, and it is the most preferable to copper.

Though a content of the metal in the ink composition is not particularly limited so far as the ink containing the subject ink composition falls within a usable range for the inkjet method, from the standpoint of adaptability to inkjet, the content of the metal in the ink composition is preferably from 5 to 70% by mass, more preferably from 10 to 50% by mass, and especially preferably from 20 to 40% by mass.

From the viewpoints of adaptability to inkjet and stability, it is preferable that the metal is contained as a particle of the subject metal or an alloy containing the subject metal in the ink, and examples of the particle include particles composed of gold, silver, copper, platinum, aluminum, palladium, nickel, or a mixture or alloy thereof. Though an average particle size of the subject particle is not particularly limited so far as the ink containing the subject particle falls within a usable range for the inkjet method, from the standpoint of adaptability to manufacture of a conductive pattern or adaptability to inkjet, the average particle size of the subject particle is preferably from 5 nm to 1,000 nm, more preferably from 5 nm to 500 nm, and still more preferably from 5 nm to 200 nm.

### (Curable Compound)

The curable compound which can be used in the invention is a compound capable of being cured with active energy ray and forms a resin upon curing.

Here, the “active energy ray” as referred to in the invention are not particularly limited so far as it is able to impart energy capable of generating an initiating species upon irradiation thereof, and it broadly include α-ray, γ-ray, X-ray, ultraviolet ray, visible light, an electron beam, and the like. Above all, from the viewpoints of curing sensitivity and easiness of availability of apparatus, ultraviolet ray and an electron beam are preferable, and ultraviolet ray is especially preferable. In consequence, the ink composition containing a curable compound which is used in the invention is preferably an ink composition which can be cured upon irradiation with ultraviolet ray as the active energy ray.

The curable compound is not particularly limited so far as it is cured upon irradiation with active energy ray, and any of radical polymerizable compounds and cationic polymerizable compounds can be used. From the viewpoints of stability and compound variation, radical polymerizable compounds are preferable, and compounds having an unsaturated double bond are more preferable.

As the compound having an unsaturated double bond, any compound having at least one radical polymerizable ethylenically unsaturated bond in a molecule thereof may be used, and compounds having a chemical form such as a monomer, an oligomer, and a polymer are included. The radical polymerizable compound may be used solely, and may be used in combination of two or more kinds thereof for the purpose of enhancing the desired characteristics. From the standpoint of controlling performances such as reactivity and physical properties, it is preferable to use two or more kinds of radical polymerizable compounds in combination.

In the invention, it is preferable to use an N-vinyl lactam as the compound having an unsaturated double bond. This is because the N-vinyl lactam is able to form a resin having good adhesion to the base material by curing, and in addition thereto, it is able to enhance an aggregation within the layer due to a coordination interaction with the metal, thereby forming strength of the layer.

Preferred examples of the N-vinyl lactam include compounds represented by the following formula (I).

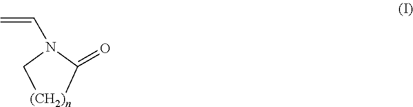

In the formula (I), n represents an integer of from 1 to 5. From the viewpoints of flexibility after the ink is cured, adhesion to the base material, and availability of a raw material, n is preferably an integer of from 2 to 4, and more preferably an integer of 2 or 4. N-Vinyl caprolactam in which n is 4 is especially preferable. N-Vinyl caprolactam is preferable because it is excellent in safety, versatile, and relatively inexpensively available, and in particular, good ink curing properties and adhesion of the cured layer to the base material are obtainable.

In addition, the foregoing N-vinyl lactam may have a substituent such as an alkyl group and an aryl group on a lactam ring thereof and may be connected with a saturated or unsaturated ring structure.

A content of the N-vinyl lactam in the ink is preferably 10% by mass or more relative to a total mass of the ink. What the N-vinyl lactam is contained in an amount of 10% by mass or more of the whole of the ink is preferable because an ink which is excellent in curing properties, flexibility of the cured layer, and adhesion of the cured layer to the base material can be provided. The content of the N-vinyl lactam in the ink is more preferably in the range of 30% by mass or more and not more than 80% by mass. The N-vinyl lactam is a compound having a relatively high melting point. What the content of the N-vinyl lactam is not more than 80% by mass is preferable because good solubility is revealed even at a low temperature of not higher than 0° C., so that a temperature range in which the ink composition can be handled becomes wide. The content of the N-vinyl lactam in the ink is still more preferably in the range of 30% by mass or more and not more than 70% by mass, and especially preferably in the range of 40% by mass or more and not more than 60% by mass.

The foregoing N-vinyl lactam may be contained solely, or may be contained in admixture of plural kinds thereof in the ink.

In addition, examples of other compounds having an unsaturated double bond include radical polymerizable compounds such as unsaturated carboxylic acids, e.g., acrylic acid, methacrylic acid, itaconic acid, crotonic acid, isocrotonic acid, and maleic acid, and salts thereof, anhydrides having an ethylenically unsaturated group, acrylonitrile, styrene, and a variety of unsaturated polyesters, unsaturated polyethers, unsaturated polyamides, and unsaturated urethanes.

Specifically, examples thereof include

monofunctional acrylates such as 2-hydroxyethyl acrylate, butoxyethyl acrylate, carbitol acrylate, tetrafurfuryl acrylate, bis(4-acryloxypolyethoxyphenyl)propane, epoxy acrylate, and phenoxyethyl acrylate,

polyfunctional acrylates such as neopentyl glycol diacrylate, ethylene glycol diacrylate, diethylene glycol diacrylate, triethylene glycol diacrylate, tetraethylene glycol diacrylate, polyethylene glycol diacrylate, dipropylene glycol diacrylate, polypropylene glycol diacrylate, pentaerythritol triacrylate, pentaerythritol tetraacrylate, dipentaerythritol tetraacrylate, trimethylolpropane triacrylate, tetramethylolmethane tetraacrylate, and oligoester acrylate,

acrylamides such as N-methylolacrylamide and diacetone acrylamide,

methacrylates such as methyl methacrylate, n-butyl methacrylate, allyl methacrylate, glycidyl methacrylate, dimethylaminomethyl methacrylate, ethylene glycol dimethacrylate, triethylene glycol dimethacrylate, polyethylene glycol dimethacrylate, polypropylene glycol dimethacrylate, trimethylolethane trimethacrylate, trimethylolpropane trimethacrylate, and 2,2-bis(4-methacryloxypolyethoxyphenyl)propane, and

besides, derivatives of allyl compounds such as allyl glycidyl ether, diallyl phthalate, and triallyl trimellitate, divinylbenzene, and acryloyl morpholine.

More specifically, radical polymerizable or crosslinkable monomers, oligomers, and polymers which are commercially available or known in the industry and which are described in Crosslinking Agent Handbook, edited by Shinzo YAMASHITA (published by Taiseisha Ltd. (1981)); UV•EB Curing Handbook (Raw Material Volume), edited by Kiyoshi KATO (published by Kobunshi Kankokai (1985)); Applications and Markets of UV•EB Curing Technologies, page 79, edited by RadTech Japan (published by CMC Publishing Co., Ltd. (1989)); Polyester Resin Handbook, written by Eiichiro TAKIYAMA (published by The Nikkan Kogyo Shimbun, Ltd. (1988)); and so on are useful.

In the invention, from the viewpoint of adhesion, it is also preferable to use, as the compound having an unsaturated double bond, the foregoing N-vinyl lactam and a compound other than the N-vinyl lactam in combination. In that case, a ratio (mass ratio) of the N-vinyl lactam to the compound other than the N-vinyl lactam in the ink is preferably from 30/70 to 70/30, more preferably from 40/60 to 60/40, and still more preferably from 55/45 to 45/55.

In addition, as the radical polymerizable compound, polymerizable compound materials of a photocuring type which are used for a photopolymerizable composition disclosed in, for example, JP-A-7-159983, JP-B-7-31399, JP-A-8-224982, JP-A-10-863, JP-A-9-134011, etc. are known, and these materials are also applicable to the ink composition of the invention.

Furthermore, it is also preferable to use a vinyl ether compound as the radical polymerizable compound. Examples of the vinyl ether compound which is suitably used include di- or trivinyl ether compounds such as ethylene glycol divinyl ether, ethylene glycol monovinyl ether, diethylene glycol divinyl ether, triethylene glycol monovinyl ether, triethylene glycol divinyl ether, propylene glycol divinyl ether, dipropylene glycol divinyl ether, butanediol divinyl ether, hydroxyethyl monovinyl ether, and trimethylolpropane trivinyl ether; and monovinyl ether compounds such as ethyl vinyl ether, n-butyl vinyl ether, isobutyl vinyl ether, hydroxybutyl vinyl ether, n-propyl vinyl ether, isopropyl vinyl ether, isopropenyl ether-O-propylene carbonate, and diethylene glycol monovinyl ether.

Of these vinyl ether compounds, from the viewpoints of curing properties, adhesion, and surface hardness, divinyl ether compounds and trivinyl ether compounds are preferable, and divinyl ether compounds are especially preferable. The vinyl ether compound may be used solely, or may be properly used in combination of two or more kinds thereof.

From the viewpoint of enhancing adhesion to the base material and strength of the layer, among the foregoing compounds, it is also preferable to use a polyfunctional acrylate monomer or a polyfunctional acrylate oligomer.

Incidentally, the “monofunctional compound” as referred to herein is a compound having one polymerizable group, and the “polyfunctional compound” as referred to herein is a compound having two or more polymerizable groups.

### (Radical Polymerization Initiator)

In the invention, it is preferable that a radical polymerization initiator is contained together with the curable compound. Examples of the radical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, and coumarins. The radical polymerization initiators are also described in JPA-2008-134585, paragraphs [0141] to [0159], and these can also be suitably used in the invention.

Various examples are also described in Saishin UV Koka Gijutsu (Latest UV Curing Technology), Technical Information Institute Co., Ltd., page 159 (1991), and Kiyomi KATO, Shigaisen Koka System (Ultraviolet Curing System), Sogo Gijutsu Center, pages 65 to 148 (1989), and these are useful in the invention.

As a commercially available photo cleavage type photo radical polymerization initiator, “IRGACURE 651”, “IRGACURE 184”. “IRGACURE 819”, “IRGACURE 907”, “IRGACURE 1870” (a mixed initiator of CGI-403 and Irg 184 (7/3)), “IRGACURE 500”, “IRGACURE 369”, “IRGACURE 1173”, “IRGACURE 2959”, “IRGACURE 4265”, “IRGACURE 4263”, “IRGACURE 127”, and “OXE 01”, all of which are manufactured by Ciba Specialty Chemicals Inc.; “KAYACURE DETX-S”, “KAYACURE BP-100”, “KAYACURE BDMK”, “KAYACURE CTX”, “KAYACURE BMS”, “KAYACURE 2-EAQ”, “KAYACURE ABQ”, “KAYACURE CPTX”, “KAYACURE EPD”, “KAYACURE ITX”, “KAYACURE QTX”, “KAYACURE BTC”, and “KAYACURE MCA”, all of which are manufactured by Nippon Kayaku Co., Ltd.; ESACURE Series, manufactured by Sartmer Company Inc. (for example, KIP100F, KB1, EB3, BP, X33, KT046, KT37, KIP150, and TZT); “LUCIRIN TPO”, manufactured BASF AG; and combinations thereof are enumerated as preferred examples.

The radical polymerization initiator is used in an amount preferably ranging from 0.1 to 15 parts by mass, and more preferably ranging from 1 to 10 parts by mass based on 100 parts by mass of the curable compound.

In addition to the photopolymerization initiator, a photosensitizer may be used. Specific examples of the photosensitizer include n-butylamine, triethylamine, tri-n-butyl phosphine, Michler's ketone, and thioxanthone. Furthermore, one or more kinds of auxiliary agents such as azide compounds, thiourea compounds, and mercapto compounds may be combined and used.

Examples of commercially available photosensitizers include “KAYACURE DMBI” and “KAYACURE EPA”, manufactured by Nippon Kayaku Co., Ltd.

The cationic polymerizable compound which can be used in the invention is not particularly limited so far as it is a compound which causes a polymerization reaction due to an acid generated from a photo acid generator and is then cured, and various known cationic polymerizable monomers which are known as a photo cationic polymerizable monomer can be used. Examples of the cationic polymerizable monomer include epoxy compounds, vinyl ether compounds, and oxetane compounds as described in, for example, JP-A-6-9714, JP-A-2001-31892, JP-A-2001-40068, JP-A-2001-55507, JP-A-2001-310938, JP-A-2001-310937, and JP-A-2001-220526.

In addition, as the cationic polymerizable compound, for example, a polymerizable compound which is applied to photo curable resins of a cationic polymerization system is known. In recent years, as a polymerizable compound which is applied to photo curable resins of a photo cationic polymerization system as sensitized to a visible light wavelength region of 400 nm or longer, compounds are laid open to public inspection in, for example, JP-A-6-43633 and JP-A-8-324137. These can also be applied to the ink composition of the invention.

In the invention, as a cationic polymerization initiator (photo acid generator) which is used in combination of the foregoing cationic polymerizable compound, for example, photoresists of a chemical amplification type and compounds which are utilized for the photo cationic polymerization are used (see Organic Materials for Imaging, pages 187 to 192 (1993), edited by The Japanese Research Association for Organic Electronics Materials and published by Bunshin Publishing, Co.).

Examples of the cationic polymerization initiator which is suitable for the invention are shown below.

That is, firstly, B(C₆F₅)₄⁻, PF₆⁻, AsF₆⁻, SbF₆⁻, and CF₃SO₃⁻ salts of aromatic onium compounds such as diazonium, ammonium, iodonium, sulfonium, and phosphonium can be exemplified. Secondly, sulfonates which generate sulfonic acid can be exemplified. Thirdly, halides which generate a hydrogen halide can also be used. Fourthly, iron-allene complexes can be exemplified.

The foregoing cationic polymerization initiator may be used solely, or may be used in combination of two or more kinds thereof.

In the invention, a content of the curable compound in the ink is preferably 70% by mass or more and not more than 100 parts by mass, and more preferably 80% by mass or more and not more than 100% by mass.

### (Polymer or Oligomer)

The polymer or oligomer contained in the ink composition which is used in the invention is not particularly limited so far as it falls within the range where the ink can be used for the inkjet method. For example, polymers or oligomers of urethane, an alkyl methacrylate, an alkyl acrylate, or the like, or mixtures thereof can be used.

As the foregoing polymer or oligomer, it is preferable to use a polymer of urethane (hereinafter also referred to as “urethane polymer” or “polyurethane”) or an oligomer of urethane (hereinafter also referred to as “urethane oligomer”), and it is more preferable to use a urethane oligomer.

Though the oligomer represented by the urethane oligomer in the invention is not limitative, for example, it refers to a polymer having a molecular weight of from 1,000 to 5,000. The polymer represented by the urethane polymer refers to, for example, a polymer having a molecular weight of 5,000 or more, and preferably a compound having a molecular weight of from 5,000 to 10,000.

As reasons why it is preferable to use the urethane polymer or oligomer, it may be assumed that in addition to the fact that the urethane polymer or oligomer has good adhesion to the base material, it is able to enhance an aggregation within the gradient layer due to a coordination interaction between the urethane bond and the metal particle, thereby forming a firm layer.

A content of the urethane polymer or oligomer in the ink is preferably 10% by mass relative to a total mass of the ink. The content of the urethane polymer or oligomer in the ink is more preferably in the range of 30% by mass or more and not more than 80% by mass, still more preferably in the range of 30% by mass or more and not more than 70% by mass, and especially preferably in the range of 40% by mass or more and not more than 60% by mass.

It is more preferable to use a polymer or oligomer having a repeating unit represented by the following general formula (1) as the urethane polymer or oligomer of the invention.

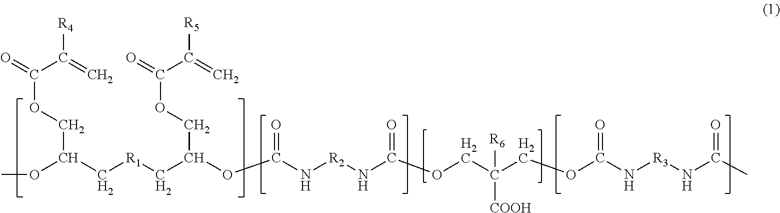

In the repeating unit represented by the foregoing general formula (1), each of R₁ to R₃ independently represents an alkylene group, an arylene group, or a biarylene group; and each of R₄ to R₆ independently represents a hydrogen atom, an alkyl group, an aryl group, or a heteroaryl group.

As the foregoing alkylene group, an alkylene group having a carbon number of from 1 to 10 is preferable.

As the foregoing arylene group, a phenylene group or a naphthylene group is preferable.

As the foregoing biarylene group, a biphenylene group or a binaphthylene group is preferable.

As the foregoing alkyl group, an alkyl group having a carbon number of from 1 to 10 is preferable.

As the foregoing aryl group, a phenyl group or a naphthyl group is preferable.

As the foregoing heteroaryl group, a pyridyl group is preferable.

As the urethane polymer or oligomer represented by the foregoing general formula (1), UN-1225 (manufactured by Negami Chemical Industrial Co., Ltd.), CN962 and CN965 (all of which are manufactured by Sartmer Company Inc.), and the like can be preferably used.

### (Solvent)

In the invention, it is preferable to prepare the ink composition containing a metal and the ink composition containing a polymer or oligomer upon being mixed with a solvent. As a matter of course, it is not disturbed to use a solvent for the ink composition containing a curable compound.

The solvent can be properly chosen from water and organic solvents and used. The solvent is preferably a liquid having a boiling point of 50° C. or higher, and more preferably an organic solvent having a boiling point in the range of from 60° C. to 300° C.

In the embodiment of the invention in which the ink composition containing a metal and the ink composition containing a compound capable of being cured with active energy ray are used in combination, it is preferable to use the solvent in such a proportion that a solid content concentration in the ink composition is from 1 to 50% by mass, and more preferably from 5 to 40% by mass. When the solid content concentration in the ink composition falls within this range, the obtained ink has a viscosity with good workability.

In the embodiment of the invention in which the ink composition containing a metal and the ink composition containing a polymer or oligomer are used in combination, it is preferable to use the solvent in such a proportion that a solid content concentration in the ink composition is from 1 to 70% by mass, and more preferably from 5 to 60% by mass. When the solid content concentration in the ink composition falls within this range, the obtained ink has a viscosity with good workability.

Examples of the solvent include alcohols, ketones, esters, nitriles, amides, ethers, ether esters, hydrocarbons, and halogenated hydrocarbons. Specifically, examples include alcohols (for example, methanol, ethanol, propanol, butanol, benzyl alcohol, ethylene glycol, propylene glycol, ethylene glycol monoacetate, cresol, etc.), ketones (for example, methyl ethyl ketone, methyl isobutyl ketone, cyclohexanone, methyl cyclohexanone, etc.), esters (for example, methyl acetate, ethyl acetate, propyl acetate, butyl acetate, ethyl formate, propyl formate, butyl formate, ethyl lactate, etc.), aliphatic hydrocarbons (for example, hexane, cyclohexane, etc.), halogenated hydrocarbons (for example, methylene chloride, methyl chloroform, etc.), aromatic hydrocarbons (for example, toluene, xylene, etc.), amides (for example, dimethylformamide, dimethylacetamide, n-methylpyrrolidone, etc.), ethers (for example, dioxane, tetrahydrofuran, ethylene glycol dimethyl ether, propylene glycol dimethyl ether, etc.), ether alcohols (for example, 1-methoxy-2-propanol, ethyl cellosolve, methyl carbinol, etc.), and fluoroalcohols (for examples, compounds described in JP-A-8-143709, paragraph [0020], JP-A-11-60807, paragraph [0037], etc.).

These solvents can be used solely or in admixture of two or more kinds thereof. Preferred examples of the solvent include toluene, xylene, methyl ethyl ketone, methyl isobutyl ketone, cyclohexanone, methanol, isopropanol, and butanol.

### (Additive)

The ink composition which is used in the invention can contain, in addition to the foregoing metal, curable compound, and polymer or oligomer, an additive such as a complexing agent, a surface tension modifier, an antifouling agent, a water resistance imparting agent, and a chemical resistance imparting agent.

For the ink containing a metal, it is preferable to use a complexing agent and a dispersant. Examples of the complexing agent include carboxylic acids such as acetic acid and citric acid, diketones such acetylacetone, and amines such as triethanolamine. In addition, examples of the dispersant include amines such as stearylamine and laurylamine.

### (Physical Properties of Ink)

From the viewpoints of uniformity at the time of layer formation, stability at the time of inkjet ejection, and storage stability of the ink, a viscosity of the ink according to the invention is preferably from 5 to 40 cP, more preferably from 5 to 30 cP, and still more preferably from 8 to 20 cP.

In addition, from the viewpoints of uniformity at the time of layer formation, stability at the time of inkjet ejection, and storage stability of the ink, a surface tension of the ink is preferably from 10 to 40 mN/m, more preferably from 15 to 35 mN/m, and still more preferably from 20 to 30 mN/m.

### (Base Material)

Next, the base material constituting a conductive pattern which is formed by the method of the invention is described.

The base material in the invention is not particularly limited, any organic, inorganic or metal-made base materials are useful.

On the other hand, at the time of adopting the method of the invention for a manufacturing method of a printed wiring board, it is preferable to use a synthetic resin-made base material which is lightweight, flexible and inexpensive. Specifically, it is preferable to use a base material made of polyethylene, polypropylene, polyvinyl chloride, polystyrene, polyvinyl acetate, an acrylic resin, a polyamide, a polyacetal, a polycarbonate, modified polyphenylene ether, polybutylene phthalate, polyethylene terephthalate, or the like. From the standpoints of low prices and high versatility, it is especially preferable to use a base material made of polyethylene terephthalate.

A thickness of the base material which can be used is usually from about 25 μm to 1,000 μm, preferably from 25 μm to 250 μm, and more preferably from 30 μm to 90 μm.

Though a width of the base material which can be used is arbitrary, from the standpoints of handling, yield, and productivity, it is usually not more than 1,000 mm, preferably not more than 800 mm, and still more preferably not more than 600 mm. A transparent support can be handled lengthily in a roll form, and a length thereof is usually within 200 m, and preferably within 100 m.

It is preferable that the surface of the base material is smooth. An average roughness Ra value thereof is preferably not more than 1 μm, more preferably not more than 0.8 μm, and still more preferably not more than 0.7 μm.

### (Fabrication of Composition Gradient Layer by the Inkjet Method)

The fabrication of a composition gradient layer by the inkjet method according to the invention is hereunder described.

In the invention, the ink containing an ink composition containing a metal and the ink containing an ink composition containing a curable compound or a polymer or oligomer are each independently ejected as two or more kinds of inks onto the base material by the inkjet method, or a mixed ink which is a mixture of the ink containing an ink composition containing a metal and the ink containing an ink composition containing a curable compound or a polymer or oligomer is ejected onto the base material by the inkjet method.

The inkjet method is not limited on the inkjet recording system so far as it is a method for undergoing image recording by an inkjet printer. Examples thereof include known systems such as a charge control system of ejecting an ink composition by utilizing an electrostatic attractive force; a drop-on-demand system utilizing a vibration pressure of piezoelectric element (pressure pulse system); an acoustic inkjet system of ejecting an ink composition by converting electric signals into acoustic beams, irradiating them on the ink composition, and utilizing a radiation pressure; and a thermal inkjet system of heating an ink composition to form air bubbles and utilizing a generated pressure (Bubble Jet (registered trademark)).

The control of droplets of the ink is carried out chiefly by a printer head. For example, in the case of a thermal inkjet system, it is possible to control a droplet ejection amount by a structure of the print head. That is, it is possible to eject the droplets in a desired size by changing the size of an ink chamber, a heating part, or a nozzle. In addition, even in the thermal inkjet system, it is also possible to realize ejection of droplets having a plurality of sizes by providing a plurality of print heads having a different size in the heating part or nozzle. In the case of a drop-on-demand system utilizing a piezoelectric element, similar to the thermal inkjet system, it is also possible to change the droplet ejection amount in view of the structure of a print head. In this regard, it is possible to achieve ejection of droplets having a plurality of sizes by a print head having the same structure by controlling a waveform of drive signals driving the piezoelectric element.

As an ejecting method (image formation method) of the ink onto the base material, there is exemplified an image formation mixing method in which the ink containing an ink composition containing a metal and the ink containing an ink composition containing a curable compound or a polymer or oligomer are supplied into separate inkjet heads, respectively and simultaneously ejected while adjusting a ratio in an ejection amount of the both inks, and mixed on the base material. In addition, as another method, there is exemplified a mixing ink method in which plural kinds of mixed inks previously prepared by mixing the ink containing an ink composition containing a metal and the ink containing an ink composition containing a curable compound or a polymer or oligomer, which mixed inks are different in a ratio between the both inks from each other, are supplied into inkjet heads, and the mixed inks having a different ratio between the ink containing an ink composition containing a metal and the ink containing an ink composition containing a curable compound or a polymer or oligomer from each other are successively ejected by selecting the head in order, thereby forming an image.

### (Preparation of Ink)

The preparation of each of the ink containing an ink composition containing a metal and the ink containing an ink composition containing a curable compound or a polymer or oligomer, the both of which are used for the image formation mixing method as described later, is described.

Each of the foregoing inks can be prepared by mixing the respective materials of the ink composition. At the time of mixing the respective materials, the materials may be stirred using a stirrer. Though a stirring time is not particularly limited, it is usually from 30 minutes to 60 minutes, and preferably from 30 minutes to 40 minutes. In addition, at the time of mixing, a temperature is usually from 10° C. to 40° C., and preferably from 20° C. to 35° C.

In the ink mixing method as described later, the above-prepared inks can be mixed and used.

### —Image Formation Mixing Method—

The method of the invention is preferably a forming method of a conductive pattern including a base material having thereon a pattern of a composition gradient layer in which the composition continuously changes from a metal to a resin in a thickness direction from the farthest side to the base material toward the nearest side to the base material, which comprises

ejecting at least two kinds of ink compositions of an ink containing an ink composition containing a metal (first ink) and an ink containing an ink composition containing a curable compound or a polymer or oligomer (second ink) onto the base material by an inkjet method, thereby fabricating the composition gradient layer, wherein

at least an ink composition containing a metal and an ink composition containing a curable compound or a polymer or oligomer are used as the at least two kinds of ink compositions, and

the inkjet method uses at least a first inkjet head and a second inkjet head, and wherein the method includes

a step of supplying the first ink containing an ink composition containing the metal into the first inkjet head,

a step of supplying the second ink containing an ink composition containing the curable compound or a polymer or oligomer into the second inkjet head,

a control step of determining a ratio of an amount of the first ink ejected from the first inkjet head to an amount of the second ink ejected from the second inkjet head,

a forming step of ejecting the first ink or the second ink from at least one of the first inkjet head and the second inkjet head according to the determined ratio, thereby forming one layer, and

a laminating (stacking) step of repeating the forming step to laminate (stack) a plurality of the layers on the base material, thereby obtaining the composition gradient layer, wherein

in the control step, the ratio is determined such that a ratio of the first ink becomes large, whereas a ratio of the second ink becomes small, in a thickness direction of the plurality of the layers from the near side to the base material toward the far side to the base material.

According to the foregoing image formation method, by repeating the step of determining a ratio of an amount of the first ink ejected from the first inkjet head to an amount of the second ink ejected from the second inkjet head and ejecting the inks according to the determined ratio to form one layer, thereby laminating a plurality of layers on the base material, wherein in the plurality of layers, the upper layer is a layer having a larger ratio of the ejection amount of the first ink and a smaller ratio of the ejection amount of the second ink, the composition gradient layer can be manufactured adopting a technology of the inkjet system.

### —Embodiment by the Image Formation Mixing Method—

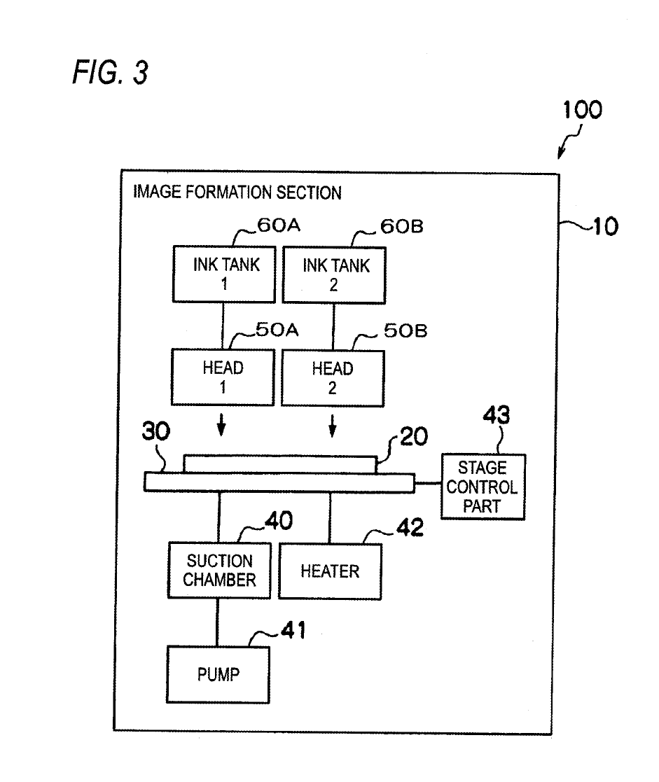

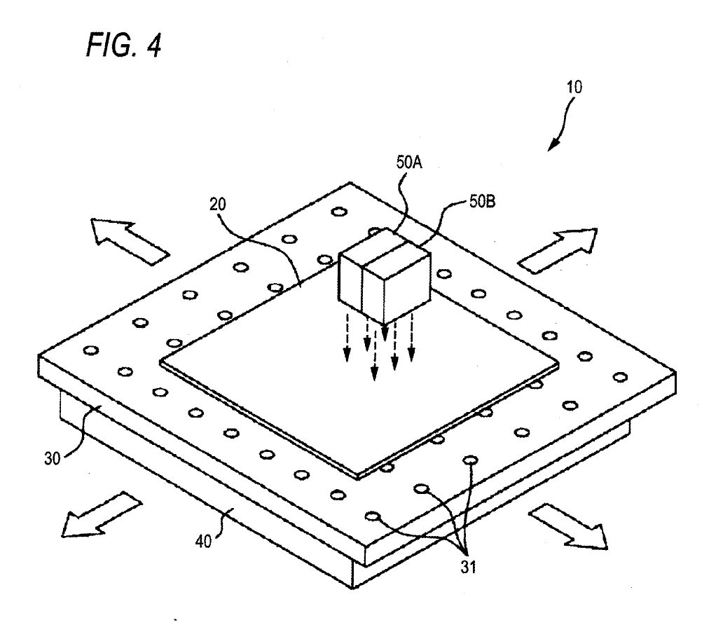

FIG. 3 is an overall configuration view of a composition gradient layer fabrication apparatus 100 according to the image formation mixing method, and FIG. 4 is a diagrammatic view of an image formation section 10 of the composition gradient layer fabrication apparatus 100. As shown in these drawings, the composition gradient layer fabrication apparatus 100 is configured to include the image formation section 10, and for the image formation section 10, an inkjet image formation apparatus of a flat head type is used. In detail, the image formation section 10 is configured to include a stage 30 on which a base material 20 is loaded; a suction chamber 40 for suctioning and holding the base material 20 loaded on the stage 30; and an inkjet head 50A (hereinafter referred to as “inkjet head 1”) and an inkjet head 50B (hereinafter referred to as “inkjet head 2”), each of which ejects each ink toward the base material 20.

The stage 30 has a width dimension which is greater than the diameter of the base material 20 and is configured so as to be movable freely in the horizontal direction by means of a non-illustrated movement mechanism. For the movement mechanism, it is possible to use, for example, a rack-and-pinion mechanism, a ball screw mechanism, or the like. A stage control part 43 (not illustrated in FIG. 4) is able to move the stage 30 to a desired position by controlling the movement mechanism.

In addition, a lot of suction holes 31 are formed on a base material holding surface of the stage 30. The suction chamber 40 is provided on the lower surface of the stage 30, and the base material 20 on the stage 30 is suctioned and held by means of vacuum suction of the suction chamber 40 by a pump 41 (not shown in FIG. 4). In addition, the stage 30 includes a heater 42 (not shown in FIG. 4), and it is possible to heat the base material 20 suctioned and held on the stage 30 with the heater 42.

The inkjet heads 1 and 2 eject inks supplied from an ink tank 60A (hereinafter referred to as “ink tank 1”) and an ink tank 60B (hereinafter referred to as “ink tank 2”) at desired positions on the base material 20, and here, a head having an actuator of a piezoelectric system is used, respectively. The inkjet heads 1 and 2 are respectively arranged and fixed as closely as possible to each other, by means of a non-illustrated fixing device.

The inks supplied from the ink tanks 1 and 2 into the inkjet heads 1 and 2 are referred to as “ink 1” and “ink 2”, respectively. In the invention, the ink containing an ink composition containing a metal (hereinafter also referred to as “metal ink”) is referred to as “ink 1”; and the ink containing an ink composition containing a curable compound (hereinafter also referred to as “curable ink”) or the ink containing an ink composition containing a polymer or oligomer (hereinafter also referred to as “resin ink”) is referred to as “ink 2”.

### (Fabrication of Composition Gradient Layer by the Image Formation Mixing Method)

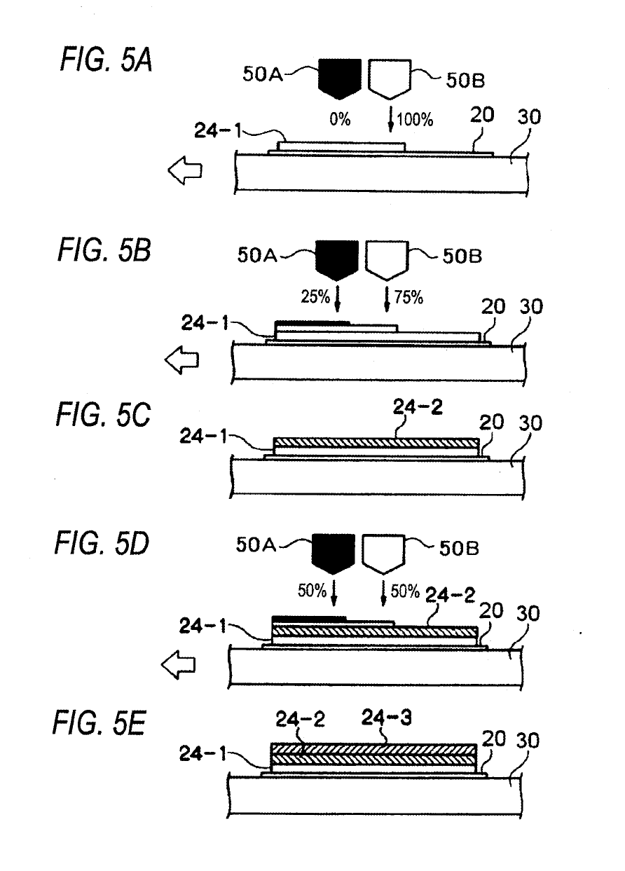

The fabrication of a composition gradient layer using the thus configured composition gradient layer fabrication apparatus 100 is described by reference to FIGS. 5A, 5B, 5C, 5D and 5E.

Firstly, the base material 20 is loaded on the stage 30 of the image formation section 10 which is situated in a nitrogen atmosphere. The base material 20 is loaded in such a manner that the rear surface comes into contact with the stage 30. Then, the base material 20 is suctioned onto the stage 30 and heated by the suction chamber 40. Here, it is preferable to heat the base material 20 at 70° C.

Subsequently, one layer or a plurality of layers of the ink (ink 2) supplied from the inkjet head 2 are laminated on the suctioned and heated base material 20, thereby forming a layer 24-1. As shown in FIG. 5A, the ink 2 is laminated by ejecting the ink 2 from the inkjet head 2 while moving the stage 30 by means of a movement mechanism (moving it in the leftward direction in FIG. 5A). Here, the ink is not ejected from the inkjet head 1.

It is preferable to dry the layer 24-1 of the ink 2 formed in this way in such a manner that the solvent component in the ink 2 is not completely evaporated off, or the curable compound of the ink 2 is not completely cured (in a state of semi-drying or semi-curing). Specifically, drying is performed with less energy than the energy applied at the time of usual drying (full drying or full curing).

Incidentally, in this specification, the terms “semi-drying” and “full drying” include the meanings of “semi-curing” and “full curing” in the case of using of the ink containing an ink composition containing a curable compound as the ink according to the invention.

In the invention, as described above, it is preferable to include a step of semi-drying the layer ejected in the foregoing forming step. In order to achieve semi-drying, for example, after completion of ejecting the ink, it is preferable to hold the system at an environmental temperature of from 40 to 120° C. for a certain time, and it is more preferable to hold the system at an environmental temperature of from 50 to 100° C. for a certain time. The holding time is preferably from 10 to 120 seconds, and more preferably from 20 to 90 seconds.

Subsequently, a mixed layer 24-2 of the ink 1 and the ink 2 is formed on the layer 24-1 of the ink 2 in a semi-dried state. As shown in FIG. 5B, the formation of this mixed layer 24-2 is carried out by ejecting the ink 1 from the inkjet head 1 and simultaneously ejecting the ink 2 from the inkjet head 2 while moving the stage 30. At that time, an ejection amount of the ink 1 and an ejection amount of the ink 2 are adjusted to a desired ratio. Here, the ink 1 and the ink 2 are ejected by adjusting the ejection amounts of respective nozzles of the inkjet heads 1 and 2 in such a manner that the ejection amount of the ink 2 is 75%, whereas the ejection amount of the ink 1 is 25%. Incidentally, the “ejection amount” of the ink as referred to in this specification means a total amount of the ink to be ejected for the purpose of forming each layer. On the other hand, a “droplet amount” of an ink droplet to be ejected from the inkjet head, as described later, means an amount of one ink droplet.

Incidentally, the adjustment of the ratio in the ejection amounts of the inks from the inkjet heads 1 and 2 may also be made by a dot pitch density of image formation. For example, it is also possible to adjust the ratio in the ejection amounts by controlling a number of nozzles for ejecting the ink to 75/25 in terms of a ratio of the inkjet head 1 to the inkjet head 2 while keeping the ejection amount of the respective nozzles of the inkjet heads 1 and 2.

After the ink ejection, as shown in FIG. 5C, the ink 1 and the ink 2 which have been ejected in the respective ejection amounts are diffused and mixed, thereby laminating the mixed layer 24-2. Since the layer 24-1 of the ink 1 is in a semi-dried state, the solvent of the ink of the mixed layer 24-2 formed thereon is received in the layer 24-1 of the ink 1 and does not wet and spread to a very great extent. That is, the heating temperature by the heater 42 needs to be adjusted in accordance with easiness of evaporation of the ink. Depending on the type of the solvent, it is possible to form an image by setting the substrate temperature to a temperature lower than 70° C. as described above, for example, about 50° C.

That is, in the foregoing forming step, it is preferable to include a step of diffusing and mixing the ejected first ink and the second ink. Examples of a method for achieving diffusion and mixing include a method of utilizing convection by heating and a method of utilizing ultrasonic waves.

In addition, the two inkjet heads are arranged as closely as possible to each other, and hence, it is possible to prevent only one of the inks from drying and causing insufficient diffusion and mixing within the layer. Incidentally, at the time of simultaneously ejecting the two inks, a droplet of the ink 1 ejected from the inkjet head 1 and a droplet of the ink 2 ejected from the inkjet head 2 may be allowed to collide with each other in the air during flight and land and combine with each other, following by deposition.

Furthermore, as described later in detail, it is preferable that each of the two inkjet heads is configured so as to have a greater width than the width of the objective base material (shorter one), and one layer is formed by one scanning. According to this, the ink 1 and the ink 2 are easily mixed with each other.

In addition, in order to promote mixing of the inks, the base material 20 may be subjected to an ultrasonic treatment by controlling the stage 30. At that time, in order that nodes by ultrasonic waves may be hardly generated, it is preferable to carry out this treatment while sweeping the frequency of the ultrasonic waves or changing the position of the base material 20.

When the mixed layer 24-2 formed in this way is in a semi-dried state similar to the layer 24-1 of the ink 2, the mixed layer 24-2 is in a state where the resin obtained as a result of curing of the curable compound or the polymer or oligomer contained in the ink 2 and the metal contained in the ink 1 are mixed in a ratio of 25/75 and superimposed.

Subsequently, a mixed layer 24-3 is formed on the mixed layer 24-2. As to the formation of this mixed layer 24-3, as shown in FIG. 5D, the inks are simultaneously ejected from the inkjet head 1 and the inkjet head 2 while moving the stage 30. Here, both of the ink 1 and the ink 2 are ejected at a ratio of 50%.

Since the mixed layer 24-2 is also in a semi-dried state, the solvent in the ink of the mixed layer 24-3 formed thereon is received in the mixed layer 24-2. As shown in FIG. 5E, after the ink ejection, the mixed layer 24-3 is laminated by diffusing and mixing the two inks.

Furthermore, the mixed layer 24-3 is also semi-dried similar to the layer 24-1 of the ink 2. The mixed layer 24-3 is in a state where the resin obtained as a result of curing of the curable compound or the polymer or oligomer contained in the ink 2 and the metal contained in the ink 1 are mixed in a ratio of 50/50 and superimposed.

In this way, respective mixed layers are formed while changing the ratio in the ejection amounts of the ink 1 and the ink 2 in a stepwise fashion (so as to produce a gradient), and finally, a layer in which the ejection amount of the ink 1 is 100% is formed.

When the formation of all of the layers has been completed, diffusion of each of the layers is advanced, and the layers formed stepwise become continuous. As a result, as shown in FIG. 1, the composition gradient layer 3 having a composition component ratio which changes from 100% for the ink 2 to 100% for the ink 1 from the side B toward the side A is formed.

By forming an upper layer while a lower layer is in a semi-dried state in this way, the diffusion may progress to a certain extent in the upper and lower layers. At that time, it is preferable that the state is avoided in which there is no interface between the upper and lower layers, i.e., the layers attain a state where they are completely mixed, so that there is no distinction between the upper and lower layers.

Incidentally, when the formation of each layer has been completed, a dummy pattern may be laminated in a region of the composition gradient layer which does not function, followed by measuring a height of the dummy pattern by an optical displacement sensor using a laser, or the like. In view of the fact that the layer thickness becomes high in a state where drying has not progressed, and the solvent remains, it is possible to determine the state of drying from the height of the dummy pattern.

As described above, it is possible to form a composition gradient layer using inkjet heads. In addition, according to the image formation mixing method of the present embodiment, there is brought such an advantage that regardless of the number of layers to be formed, few types of inks and a small number of inkjet heads only are required. Any number of mixed layers of the ink 1 and the ink 2 may be laminated, provided that the layers are formed in such a manner that the mixing ratio of the respective inks has a stepwise gradient.

In addition, in the forming step of each layer, from the viewpoints of layer thickness control and fine line formability, a droplet amount of the ink droplet ejected from each of the first inkjet head and the second inkjet head is preferably from 0.3 to 100 pL, more preferably from 0.5 to 80 pL, and still more preferably from 0.7 to 70 pL.

In the forming step of each layer, from the viewpoints of layer thickness control and fine line formability, a droplet size of the ink droplet ejected from each of the first inkjet head and the second inkjet head is preferably from 1 to 300 μm, more preferably from 5 to 250 μm, and still more preferably from 10 to 200 μm.

Furthermore, in the forming step of each layer, as to the ink having a smaller ratio of the ejection amount between the first ink and the second ink, it is preferable that at least one of the droplet amount and the droplet size of the ink droplet ejected from the inkjet head is smaller than that in the ink in which the foregoing ratio is larger. For example, it is preferable that the ink droplet of the ink in which the foregoing ratio is smaller is from 0.3 to 60 pL, whereas the ink droplet of the ink in which the foregoing ratio is larger is from 1 to 100 pL. According to this, it is possible to shorten the time for diffusion and mixing, or to enhance the uniformity of mixing.

Incidentally, the “droplet size” of the ink droplet as referred to herein means a length of the droplet diameter, and it can be measured from a photograph of the flying state at the time of inkjet ejection.

In the present embodiment, the composition gradient layer 3 having a composition ratio which changes from 100% for the ink 2 to 100% for the ink 1 from the side B toward the side A is formed. However, it is not always required to form a layer in such a manner that the ink 2 or the ink 1 is 100% on the side B or the side A. So far as the composition gradient layer 3 is obtainable, the ratio of the ink 2 or the ink 1 on the side B or the side A can be arbitrarily changed.

The ratio of the ink 2 or the ink 1 on the side B or the side A can be properly adjusted depending upon characteristics of the composition gradient layer which is intended to be obtained, such as adhesion and conductivity.

In addition, in the present embodiment, the inks are simultaneously ejected at the inkjet head 1 and the inkjet head 2, thereby forming the respective layers. However, the inks may be ejected sequentially.

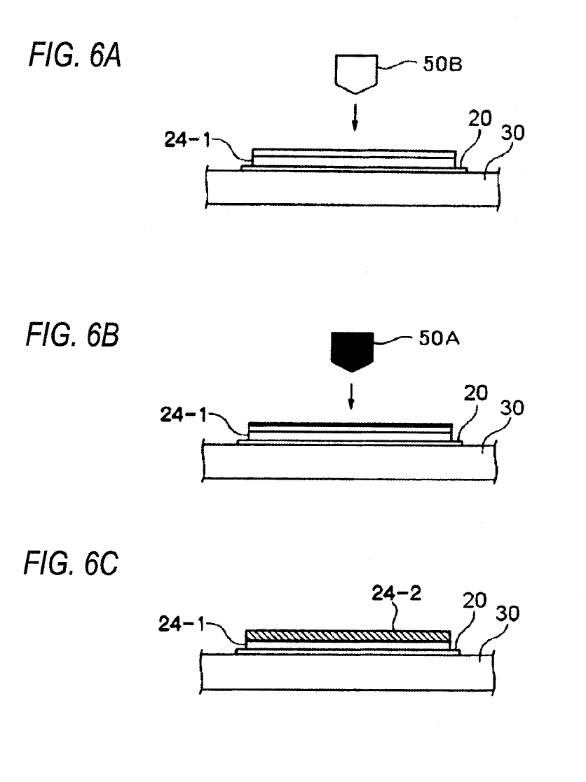

For example, in the case of forming the mixed layer 24-2, as shown in FIG. 6A, first of all, the ink 2 is ejected on the whole surface of the layer 24-1 of the ink 2 from inkjet head 2. Subsequently, as shown in FIG. 6B, the ink 1 is ejected on the whole surface from the inkjet head 1. Thereafter, as shown in FIG. 6C, by diffusing and mixing the respective inks, the mixed layer 24-2 can be similarly formed.

In the case of forming one layer by ejecting the respective inks successively in this way, when there is a difference in the ejection amount between the two inks, namely, when the ratio between the ejection amounts of the two inks is not 50%/50%, it may be constituted in such a manner that the ink having a larger ejection amount is ejected first. In particular, in the case where there is severe drying of the ink ejected first, or the like, the smaller the ejection amount of the ink, the more rapidly drying occurs. Therefore, it is desirable to eject the ink of a larger ejection amount first. According to this, mixing of the two kinds of inks can be advanced smoothly.

Furthermore, in that case, the ink having a smaller ejection amount, which is ejected subsequently, may be ejected at a higher dot pitch density by a smaller droplet (the droplet amount is smaller, or the droplet size is smaller). According to this, the time required for diffusion and mixing can be shortened.

In addition, it is also possible to deposit the ink ejected subsequently in a superimposed fashion, on the positions where the ink ejected first has been deposited. In particular, in the case where intermittent ejection is performed, and the dots are separated from each other, when a droplet is deposited before a droplet ejected at the same position as the ink ejected first has dried, the respective inks are easily mixed with each other.

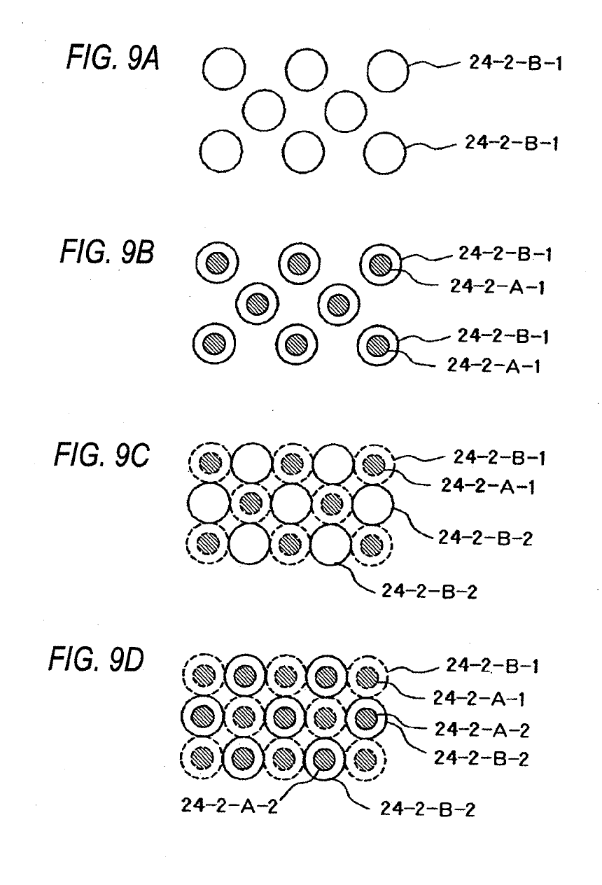

For example, it is supposed that at the time of forming the mixed layer 24-2, the ink 2 has been ejected by intermittent ejection by the inkjet head 2 in first scanning. FIG. 9A shows the ink 2 (24-2-B-1) which has been deposited on the layer 24-1 of the ink layer 1.

Subsequently, in second scanning, the ink 1 is ejected by intermittent ejection from the inkjet head 1. At that time, as shown in FIG. 9B, the inkjet head 1 performs ejection in such a manner that the ejected ink 1 (24-2-A-1) is deposited in a superimposed fashion at the same position as the ink 2 (24-2-B-1) deposited at the first scanning.

Furthermore, the ink 2 is ejected intermittently from the inkjet head 2 in third scanning. FIG. 9C shows the ink 2 (24-2-B-2) which has been deposited between the dots of the ink 2 (24-2-B-1).

Thereafter, in fourth scanning, the inkjet head 1 performs ejection in such a manner that the ink 1 is deposited in a superimposed fashion at the same positions as the ink 2 (24-2-B-2). As shown in FIG. 9D, the inkjet head 1 performs ejection in such a manner that the ejected ink 1 (24-2-A-2) is deposited in a superimposed fashion at the same positions as the ink 2 (24-2-B-2) deposited in the second scanning.

Thereafter, in a similar fashion, the inks are ejected onto the whole surface of the layer 24-1 of the ink 1 and then diffused and mixed.

By ejecting the inks in this way, it is possible to shorten the time required for diffusion and mixing at the time of forming the mixed layer 24-2.

In addition, in the case where one of the inks dries more quickly, that ink may be ejected afterward.

In addition, in the present embodiment, the respective mixed layers are formed using two pure inks of the ink 1 and the ink 2, but an ink obtained by mixing these inks may be used in combination. For example, it may be considered to form a mixed layer by simultaneously using inks of three types composed of two pure inks and a mixed ink of the ink 1 and the ink 2 in a mixing ratio of 50/50. Though the number of inkjet heads increases in accordance with the mixed ink, since the two pure inks are sufficiently mixed together in advance in the mixed ink, the time required for diffusion and mixing after ejection of the ink can be shortened.

### —Ink Mixing Method—

The method of the invention is preferably a forming method of a conductive pattern including a base material having thereon a pattern of a composition gradient layer in which the composition continuously changes from a metal to a resin in a thickness direction from the farthest side to the base material toward the nearest side to the base material, which comprises

ejecting at least two kinds of ink compositions of an ink containing an ink composition containing a metal (first ink) and an ink containing an ink composition containing a curable compound or a polymer or oligomer (second ink) onto the base material by an inkjet method, thereby fabricating the composition gradient layer, wherein

at least an ink containing an ink composition containing a metal and an ink containing an ink composition containing a curable compound or a polymer or oligomer are used as the at least two kinds of ink compositions, and

the inkjet method uses a plurality of inkjet heads, and wherein the method includes

a step of supplying a plurality of mixed inks which are a mixture of the first ink containing an ink composition containing the metal and the second ink containing an ink composition containing the curable compound or a polymer or oligomer, and which are different in a mixing ratio from each other, into the plurality of inkjet heads, respectively,

a selecting step of successively selecting one inkjet head from the plurality of inkjet heads in decreasing order of a ratio of the second ink contained in the mixed ink supplied into the inkjet head,

a forming step of ejecting the mixed ink from the selected inkjet head, thereby forming one layer, and

a laminating step of repeating the forming step to laminate a plurality of the layers on the base material, thereby obtaining the composition gradient layer.

According to the foregoing method, a plurality of mixed inks which is a mixture of the first ink and the second ink and in which the inks are mixed in a different ratio, respectively are supplied into the respective inkjet heads, and the respective layers are formed by ejecting the mixed ink from the inkjet head into which the mixed ink having a low ratio of the first ink is supplied sequentially, thereby laminating a plurality of layers on the base material. Thus, a composition gradient layer can be manufactured adopting the technology of an inkjet system.

### —Embodiment by the Ink Mixing Method—

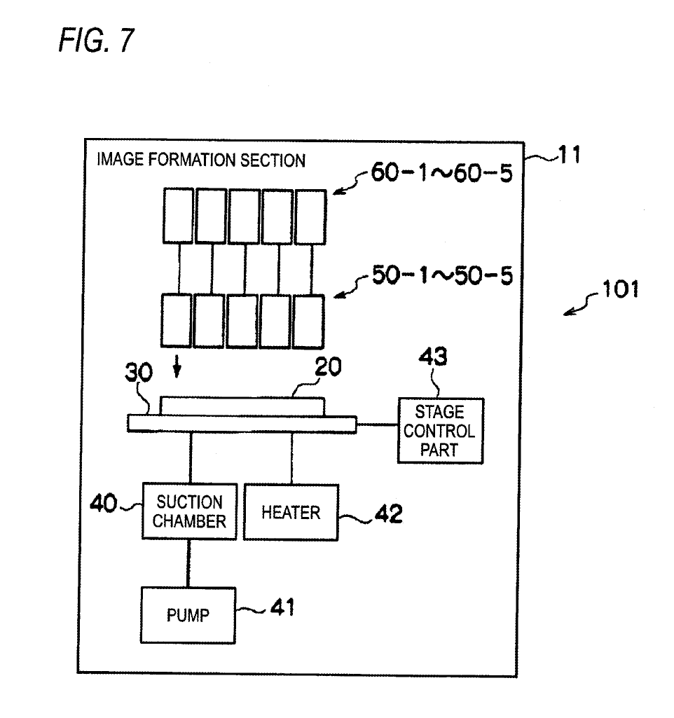

FIG. 7 is an overall configuration view of a composition gradient layer fabrication apparatus 101 according to a second embodiment. As shown in FIG. 7, the composition gradient layer fabrication apparatus 101 according to the present embodiment includes an image formation section 11, and the image formation section 11 includes ink tanks 60-1 to 60-5 which store five kinds of inks, and inkjet heads 50-1 to 50-5 into which inks are supplied from the respective ink tanks 60-1 to 60-5. The inkjet heads 50-1 to 50-5 eject inks supplied from the respective ink tanks 60-1 to 60-5 onto the base material 20.

The inks supplied from the ink tanks 60-1 to 60-5 into the inkjet heads 50-1 to 50-5 have respective mix ratios of the ink 1 and the ink 2 of 0/100, 25/75, 50/50, 75/25, and 100/0. That is, a pure ink of the ink 2 is supplied from the ink tank 60-1, a pure ink of the ink 1 is supplied from the ink tank 60-5, and mixed inks in which the ink 1 and the ink 2 are mixed in prescribed ratios are supplied from the ink tanks 60-2 to 60-4.

### [Fabrication of Composition Gradient Layer by the Ink Mixing Method]

Similar to the embodiment by the image formation mixing method, the base material 20 is loaded on the stage 30 and then suctioned and heated.

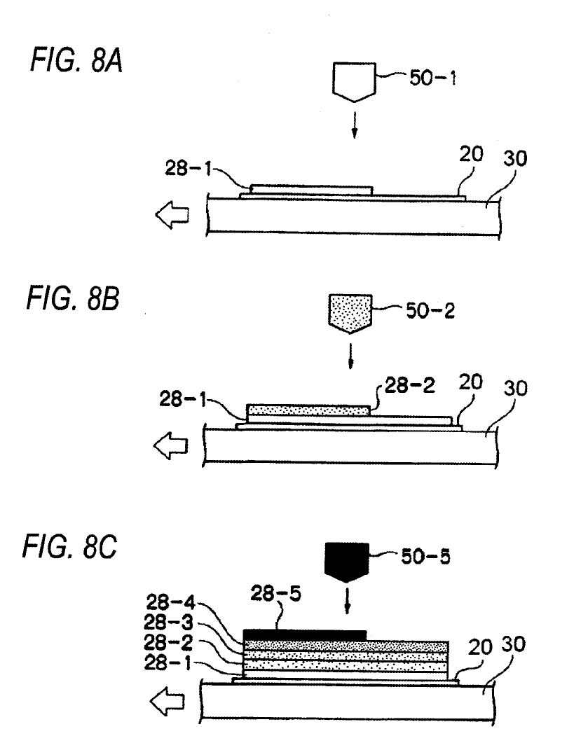

Subsequently, a layer 28-1 of the ink 2 is formed by laminating one layer or a plurality of layers of the ink 2 on the suctioned and heated base material. As shown in FIG. 8A, the ink 2 is laminated by ejecting an ink supplied from the ink tank 60-1 (mixing ratio of the ink 1 and the ink 2: 0/100) onto the base material from the inkjet head 50-1 while moving the stage 30 by means of a movement mechanism (moving it in the leftward direction in FIG. 8A). At that time, an ink is not ejected from the other inkjet heads 50-2 to 50-5.

In consequence, the thus formed layer 28-1 of the ink 2 is a layer similar to the layer 24-1 of the ink 2 shown in FIGS. 5A to 5E. Here, when the ink is dried to such an extent that the solvent in the ink 2 is evaporated, or the curable compound in the ink 2 is not completely cured (semi-dried or semi-cured), the metal contained in the ink 1 is superimposed each other.

In this ink mixing method, it is also preferable to include a step of semi-drying the layer ejected in the foregoing forming step. In order to achieve semi-drying, for example, after completion of ejecting the ink, it is preferable to hold the system at an environmental temperature of from 40 to 120° C. for a certain time, and it is more preferable to hold the system at an environmental temperature of from 50 to 100° C. for a certain time. The holding time is preferably from 10 to 120 seconds, and more preferably from 20 to 90 seconds.

Subsequently, a mixed layer 28-2 is formed on the layer 28-1 of the ink 2 by ejecting a mixed ink (a mixed ink of the ink 1 and the ink 2 in a mixing ratio of 25/75) supplied from the ink tank 60-2 by the inkjet head 50-2.

In forming the mixed layer 28-2, as shown in FIG. 8B, the mixed ink is ejected from the inkjet head 50-2 while moving the stage 30. Similar to the embodiment by the image formation mixing method, since the layer 28-1 of the ink 2 is in a semi-dried state, the solvent of the ink of the mixed layer 28-2 formed thereon is received in the layer 28-1 of the ink 2 and does not wet and spread to a very great extent. In consequence, the heating temperature needs to be adjusted in accordance with easiness of evaporation of the ink

By semi-drying this mixed layer 28-2, the mixed layer 28-2 assumes a state where the metal contained in the ink 1 and the resin obtained as a result of curing of the curable compound or the polymer or oligomer contained in the ink 2 are superimposed.

Furthermore, a mixed layer 28-3 is formed on the mixed layer 28-2 by ejecting a mixed ink (a mixed ink of the ink 1 and the ink 2 in a mixing ratio of 50/50) supplied from the ink tank 60-3 by the inkjet head 50-3 (not illustrated in FIGS. 8A, 8B and 8C).

Since the mixed layer 28-2 is in a semi-dried state, the solvent of the ink of the mixed layer 28-3 formed thereon is received in the mixed layer 28-2. Furthermore, the mixed layer 28-3 is also semi-dried.

In this way, respective mixed layers (28-2 to 28-4) are laminated by ejecting the respective mixed inks in order from the largest mixing ratio of the ink 2 (i.e., in order from the smallest mixing ratio of the ink 1), and finally, a layer 28-5 composed of 100% of the ink 1 (layer of the ink 1) is formed by ejecting the ink 1 (ink having a mixing ratio of the ink 1 and the ink 2 of 100/0) supplied from the ink tank 60-5 by the inkjet head 50-5 (FIG. 8C).

When the formation of all of the layers has been completed, as shown in FIG. 1, the composition gradient layer 3 having a composition component ratio which changes from 100% for the ink 2 to 100% for the ink 1 is formed.

In addition, in the forming step of each layer, from the viewpoint of stable ejection, a droplet amount of the ink droplet ejected from the inkjet head is preferably from 0.5 to 150 pL, more preferably from 0.7 to 130 pL, and still more preferably from 1 to 100 pL.

In the forming step of each layer, from the viewpoint of good layer formability, a droplet size of the ink droplet ejected from the inkjet head is preferably from 2 to 450 μm, more preferably from 5 to 350 μm, and still more preferably from 10 to 250 μm.

As described above, it is possible to form a composition gradient layer using mixed inks. According to the ink mixing method of the present embodiment, since sufficient mixing is achieved at the stage of the ink, it is possible to fabricate a composition gradient layer with high precision on a change of the gradient. In addition, as compared with the embodiment by the image formation mixing method, a time is not required for diffusing and mixing two kinds of functional inks, and therefore, there is brought such an advantage that the process time may be short.

In the present embodiment, though three mixed layers of the ink 1 and the ink 2 are formed, the number of layers is not particularly limited thereto. Any number of layers may be formed so far as the layers are laminated so as to achieve a gradient of the mixing ratio of the respective inks. Incidentally, it is necessary to prepare ink tanks and inkjet heads corresponding to the number of layers to be formed.

Furthermore, in the present embodiment, the composition gradient layer 3 having a composition component ratio which changes from 100% for the ink 2 to 100% for the ink 1 is formed. However, it is not always required to adopt a composition component ratio in which the ink 2 is 100%, or the ink 1 is 100%. So far as the composition gradient layer 3 is obtainable, the foregoing composition component ratio can be arbitrarily changed.

The foregoing composition component ratio can be properly adjusted depending upon characteristics of the composition gradient layer which is intended to be obtained, such as adhesion and conductivity.

### [Conductive Pattern and Printed Wiring Board]

Though a line width of the conductive pattern according to the invention is not particularly limited, it is preferably 1 μm or more and not more than 200 μm, and more preferably 2 μm or more and not more than 150 μm. So far as the line width is 1 μm or more and not more than 200 μm, a conductive pattern with low resistance can be relatively easily formed.

A volume resistivity of the conductive pattern is preferably not more than 1×10⁻² Ω·cm, more preferably not more than 1×10⁻³ Ω·cm, and still more preferably not more than 1×10⁻⁴ Ω·cm. Though it is preferable that the volume resistivity is low as far as possible, an actually lower limit value of the volume resistivity is 1×10⁻⁴ Ω·cm or more.

The forming method of a conductive pattern according to the invention can be preferably applied to a manufacturing method of a printed wiring board.

The printed wiring board manufactured by the subject manufacturing method is excellent in adaptability to manufacture and high in adhesion and conductivity and is free from fusion of conductive patterns each other, and therefore, it is thoroughly applicable to miniaturized or thinned devices.

### EXAMPLES

The invention is hereunder specifically described by reference to the following Examples, but it should not be construed that the scope of the invention is limited thereto.

### Example 1

### Fabrication of Curable Compound-Containing Ink

- Curable ink A1 -

| | | |
|---|---|---|
| N-Vinyl caprolactam (manufactured by Sigma-Aldrich): | 50 | g |
| Dipropylene glycol diacrylate (manufactured by Akcros | 40 | g |
| Chemicals): | | |
| IRGACURE 184 (manufactured by Ciba Specialty | 4 | g |
| Chemicals Inc.): | | |
| LUCIRIN TPO (manufactured by BASF AG): | 6 | g |

The foregoing raw materials were charged into a 2-liter vessel and stirred for 20 minutes while keeping a liquid temperature at not higher than 40° C. by a Silverson high-speed stirrer. Thereafter, the resultant was filtered with a 2-μm filter to fabricate a curable ink A1.

### Fabrication of Metal Ink

- Metal ink B1 -

| | |
|---|---|
| Copper nano particle MD50 (average particle size: 50 nm, | 10 g |
| manufactured by Ishihara Sangyo Kaisha, Ltd.): | |
| Laurylamine (manufactured by Tokyo Chemical Industry | 3 g |
| Co., Ltd.): | |
| Cyclohexanone (manufactured by Wako Pure Chemical | 27 g |
| Industries, Ltd.): | |

The foregoing raw materials and 60 g of zirconia beads were charged into a 200-mL vessel and sealed, and the contents were dispersed for 30 minutes using a paint shaker dispersing machine (manufactured by Toyo Seiki Seisaku-sho, Ltd.). Thereafter, the resultant was filtered with a 2-μm filter to fabricate a metal ink B1.

### Fabrication of Conductive Pattern

On a transparent PET base material (thickness: 150 μm, manufactured by Fujifilm Corporation), a conductive pattern (line width: 100 μm) composed of a composition gradient layer having a thickness of 10 μm was formed by the following inkjet image formation method A and then evaluated with respect to adhesion of the conductive pattern to the base material, conductivity and pattern formation.

### —Inkjet Image Formation Method A—

The metal ink B1 and the curable ink A1 were respectively filled in the ink tank 1 and the ink tank 2 as shown in FIG. 3. The inks to be supplied into the inkjet head 1 and the inkjet head 2 are the metal ink B1 and the curable ink A1, respectively.

Firstly, an ink droplet to be ejected from the inkjet head 2 was controlled so as to have a droplet amount of 10 pL and a droplet size of 30 μm, and the curable ink A1 was ejected from the inkjet head 2 in a nitrogen gas atmosphere. Here, the ink layer 1 was formed without ejecting the metal ink B1 from the inkjet head 1 (namely, a ratio (% by mass) of an ejection amount of the ink ejected from the inkjet head 2 to an ejection amount of the ink ejected from the inkjet head 1 is 100/0) and semi-cured upon drying at 80° C. for 30 seconds. Specifically, curing was performed with energy (accumulated exposure amount with a metal halide lamp: 1,000 mJ/cm²) which is smaller than energy giving full curing.

Subsequently, lamination and semi-curing were repeated by changing the ratio (% by mass) of an ejection amount of the ink ejected from the inkjet head 2 to an ejection amount of the ink ejected from the inkjet head 1 to 75/25 (ink layer 2), 50/50 (ink layer 3), 25/75 (ink layer 4), and 0/100 (ink layer 5), respectively, and finally, full curing (accumulated exposure amount with a metal halide lamp: 5,000 mJ/cm²) was performed to form a conductive pattern composed of the composition gradient layer.

Here, at the time of forming the ink layer 2, an ink droplet of the metal ink B1 to be ejected from the inkjet head 1 was adjusted so as to have a droplet amount of 5 pL and a droplet size of 20 μm, and an ink droplet of the curable ink A1 to be ejected from the inkjet head 2 was adjusted so as to have a droplet amount of 10 pL and a droplet size of 30 μm. At the time of forming the ink layer 3, an ink droplet of the metal ink B1 was adjusted so as to have a droplet amount of 10 pL and a droplet size of 30 μm, and an ink droplet of the curable ink A1 was adjusted so as to have a droplet amount of 10 pL and a droplet size of 30 μm. At the time of forming the ink layer 4, an ink droplet of the metal ink B1 was adjusted so as to have a droplet amount of 10 pL and a droplet size of 30 μm, and an ink droplet of the curable ink A1 was adjusted so as to have a droplet amount of 5 pL and a droplet size of 20 μm. At the time of forming the ink layer 5, an ink droplet of the metal ink B1 was adjusted so as to have a droplet amount of 10 pL and a droplet size of 30 μm. In addition, a thickness of each of the ink layers 1 to 5 after full curing was adjusted to 2 μm.

### Evaluation of Conductive Pattern

### <Adhesion>

The formed conductive layer was subjected to a cross hatch test (EN 1802409). Evaluation criteria were made in conformity with 1802409, and the results were shown by a point system of evaluation of from point 0 to point 5.

### <Conductivity>

The formed conductive layer was measured for a volume resistivity using Loresta MP MCP-T350 (manufactured by Mitsubishi Chemical Corporation), and the results thereof were evaluated by the following criteria.

4: Volume resistivity: Not more than 1×10⁻⁵ Ω·m

3: Volume resistivity: More than 1×10⁻⁵ Ω·m and not more than 1×10⁻⁴ Ω·m

2: Volume resistivity: More than 1×10⁻⁴ Ω·m and not more than 1×10⁻² Ω·m

1: Volume resistivity: More than 1×10⁻² Ω·m

### <Pattern Shape>

On a transparent PET base material (thickness: 150 μm, manufactured by Fujifilm Corporation), a conductive pattern composed of a composition gradient layer having a line width of 100 μm was subjected to image formation by means of inkjet, linearity of an image-formed straight line was visually evaluated, and evaluation was made by a boundary sample according to the following evaluation criteria.

4: The both widths of the line were a straight line, and a line width within 100 μm±5 μm was reproduced.

3: A zigzag remained in the both widths of the line, and a line width within 100 μm±10 μm was reproduced.

2: A zigzag remained remarkably in the both widths of the line, and a line width within 100 μm±20 μm was reproduced.

1: A zigzag remained remarkably in the both widths of the line, the line width was non-uniform, and bulge occurred partially.

The evaluation results of the conductive pattern formed in Example 1 are shown in the following Table 1.

### Example 2

As inks that are a mixture of the curable ink A1 and the metal ink B1 used in Example 1, an ink G1 (mixing ratio (% by mass) of A1/B1=75/25), an ink G2 (mixing ratio (% by mass) of A1/B1=50/50), and an ink G3 (mixing ratio (% by mass) of A1/B1=25/75) were fabricated. On a transparent PET base material (thickness: 150 μm, manufactured by Fujifilm Corporation), a conductive pattern composed of a composition gradient layer (line width: 100 μm) having a thickness of 10 μm was formed by the following inkjet image formation method B by using five print heads in which five kinds of the foregoing inks also including the inks A1 and B1 had been filled in order of A1 (lowermost layer), G1, G2, G3, and B1 (uppermost layer). By using the transparent PET base material having the present conductive pattern formed thereon, adhesion of the composition gradient layer to the base material, conductivity and pattern formation were evaluated. The results are shown in the following Table 1.

### —Inkjet Image Formation Method B—

The inks A1, G1, G2, G3 and B1 were respectively filled in the ink tanks 60-1 to 60-5 as shown in FIG. 7. The inks to be supplied into the inkjet heads 50-1 to 50-5 are the inks A1, G1, G2, G3 and B1, respectively.

Firstly, the ink A1 was ejected from the inkjet head 50-1 in a nitrogen gas atmosphere while controlling ink droplets to be ejected from the inkjet head so as to have a droplet amount of 10 pL and a droplet size of 30 μm.

The thus formed ink A1 layer was semi-cured. Specifically, curing was performed with energy (accumulated exposure amount with a metal halide lamp: 1,000 mJ/cm²) which is smaller than energy giving full curing.

Subsequently, the ink G1 was similarly ejected from the inkjet head 50-2, and the ink G1 layer was laminated and semi-cured. This was also repeated with respect to the inks G2. G3 and B1, lamination and semi-curing were repeated, and finally, full curing (accumulated exposure amount with a metal halide lamp: 5,000 mJ/cm²) was performed to form a composition gradient layer.

Incidentally, a thickness of each of the ink layers A1, G1, G2, G3 and B1 after full curing was adjusted to 2

### Examples 3 to 12

Conductive patterns composed of a composition gradient layer (line width: 100 μm) having a thickness of 10 μm were formed in the same method as that in Example 1, except that the metal and the curable compound contained in the metal ink and the curable ink were respectively replaced by those described in the following Table 1, and then evaluated with respect to adhesion to the base material, conductivity, and pattern shape. The results are shown in the following Table 1.

### Comparative Example 1

On a transparent PET base material (thickness: 150 μm, manufactured by Fujifilm Corporation), a conductive pattern (line width: 100 μm) having a thickness of 10 μm, which was configured of only one layer, was formed using only the metal ink B1 used in Example 1 by means of inkjet image formation, and then evaluated with respect to adhesion to the base material, conductivity, and pattern shape. The results are shown in the following Table 1.

### Comparative Example 2

On a transparent PET base material (thickness: 150 μm, manufactured by Fujifilm Corporation), a conductive pattern (line width: 100 μm) having a thickness of 10 μm, which was configured of only one layer, was formed using a mixed ink E1 obtained by previously mixing the metal ink B1 and the curable ink A1 used in Example 1 (mixing ratio (mass ratio)=1/1) and well stirring the contents, by means of inkjet image formation, and then evaluated with respect to adhesion to the base material, conductivity, and pattern shape. The results are shown in the following Table 1.

### Comparative Example 3

The mixed inks G1, G2 and G3, the metal ink B1, and the curable ink A1 used in Example 2 were prepared in advance and subjected to bar coating for every layer in order of A1 (lowermost layer), G1, G2, G3, and B1 (uppermost layer) on a transparent PET base material (thickness: 150 μm, manufactured by Fujifilm Corporation) and full curing for every layer (accumulated exposure amount with a metal halide lamp: 5,000 mJ/cm²), thereby achieving lamination. There was thus formed a conductive pattern composed of a composition gradient layer (line width: 100 μm) having a thickness of 10 μm. Incidentally, a thickness of each of the ink layers A1, G1, G2, G3 and B1 after full curing was adjusted to 2 μm. By using the transparent PET base material having the present conductive patter formed thereon, adhesion between the composition gradient layer and the base material and conductivity were evaluated. The results are shown in the following Table 1.

TABLE 1

| | Type of ink | | | Curable ink-constituting material | | | | | | |
|---|---|---|---|---|---|---|---|---|---|---|
| | | Curable | | | Content ratio | | Content ratio | | | |
| | Metal ink | ink | Metal material in metal ink | Curable compound 1 | (wt %) | Curable compound 2 | (wt %) | Adhesion | Conductivity | Pattern shape |
| Example No. | | | | | | | | | | |
| 1 | B1 | A1 | Copper nano particle MD50 [average | N-Vinyl caprolactam | 50 | Dipropylene glycol diacrylate | 40 | 0 | 4 | 4 |
| | | | particle size: 50 nm] (manufactured by | (manufactured by | | (manufactured by Akcros | | | | |
| | | | Ishihara Sangyo Kaisha, Ltd.) | Sigma-Aldrich) | | Chemicals) | | | | |
| 2 | B1 | A1 | Copper nano particle MD50 [average | N-Vinyl caprolactam | 50 | Dipropylene glycol diacrylate | 40 | 0 | 4 | 4 |
| | | | particle size: 50 nm] (manufactured by | (manufactured by | | (manufactured by Akcros | | | | |
| | | | Ishihara Sangyo Kaisha, Ltd.) | Sigma-Aldrich) | | Chemicals) | | | | |
| 3 | B1 | A2 | Copper nano particle MD50 [average | N-Vinyl caprolactam | 50 | Dipropylene glycol diacrylate | 40 | 0 | 4 | 4 |
| | | | particle size: 50 nm] (manufactured by | (manufactured by | | (manufactured by Akcros | | | | |
| | | | Ishihara Sangyo Kaisha, Ltd.) | Sigma-Aldrich) | | Chemicals) | | | | |
| 4 | B1 | A3 | Copper nano particle MD50 [average | N-Vinylpyrrolidone | 50 | Dipropylene glycol diacrylate | 40 | 91 | 4 | 4 |
| | | | particle size: 50 nm] (manufactured by | (manufactured by | | (manufactured by Akcros | | | | |
| | | | Ishihara Sangyo Kaisha, Ltd.) | Sigma-Aldrich) | | Chemicals) | | | | |
| 5 | B1 | A4 | Copper nano particle MD50 [average | N-Vinyl caprolactam | 50 | Divinylbenzene | 40 | 0 | 4 | 4 |
| | | | particle size: 50 nm] (manufactured by | (manufactured by | | (manufactured by Tokyo | | | | |
| | | | Ishihara Sangyo Kaisha, Ltd.) | Sigma-Aldrich) | | Chemical Industry Co., Ltd.) | | | | |
| 6 | B1 | A5 | Copper nano particle MD50 [average | N-Vinyl caprolactam | 50 | Phenoxyethyl acrylate | 40 | 0 | 4 | 4 |
| | | | particle size: 50 nm] (manufactured by | (manufactured by | | (manufactured by Tokyo | | | | |
| | | | Ishihara Sangyo Kaisha, Ltd.) | Sigma-Aldrich) | | Chemical Industry Co., Ltd.) | | | | |
| 7 | B1 | A6 | Copper nano particle MD50 [average | N-Vinyl caprolactam | 30 | Phenoxyethyl acrylate | 60 | 0 | 4 | 4 |
| | | | particle size: 50 nm] (manufactured by | (manufactured by | | (manufactured by Tokyo | | | | |
| | | | Ishihara Sangyo Kaisha, Ltd.) | Sigma-Aldrich) | | Chemical Industry Co., Ltd.) | | | | |
| 8 | B1 | A7 | Copper nano particle MD50 [average | — | — | Phenoxyethyl acrylate | 90 | 1 | 4 | 4 |
| | | | particle size: 50 nm] (manufactured by | | | (manufactured by Tokyo | | | | |
| | | | Ishihara Sangyo Kaisha, Ltd.) | | | Chemical Industry Co., Ltd.) | | | | |
| 9 | B2 | A1 | Copper nano particle MD200 [average | N-Vinyl caprolactam | 50 | Dipropylene glycol diacrylate | 40 | 0 | 4 | 4 |
| | | | particle size: 200 nm] (manufactured by | (manufactured by | | (manufactured by Akcros | | | | |
| | | | Ishihara Sangyo Kaisha, Ltd.) | Sigma-Aldrich) | | Chemicals) | | | | |
| 10 | B3 | A1 | Silver nano particle NPS-J [average | N-Vinyl caprolactam | 50 | Dipropylene glycol diacrylate | 40 | 0 | 4 | 4 |
| | | | particle size: 5 nm] (manufactured by | (manufactured by | | (manufactured by Akcros | | | | |
| | | | Harima Chemicals, Inc.) | Sigma-Aldrich) | | Chemicals) | | | | |
| 11 | B1 | A8 | Copper nano particle MD50 [average | Acryloyl morpholine | 50 | Dipropylene glycol diacrylate | 40 | 1 | 4 | 4 |
| | | | particle size: 50 nm] (manufactured by | (manufactured by Kojin | | (manufactured by Akcros | | | | |
| | | | Ishihara Sangyo Kaisha, Ltd.) | Co., Ltd.) | | Chemicals) | | | | |
| 12 | B1 | A9 | Copper nano particle MD50 [average | N-Vinylpyrrolidone | 90 | — | — | 1 | 4 | 4 |
| | | | particle size: 50 nm] (manufactured by | (manufactured by | | | | | | |
| | | | Ishihara Sangyo Kaisha, Ltd.) | Sigma-Aldrich) | | | | | | |
| Comparative | | | | | | | | | | |
| Example No. | | | | | | | | | | |
| 1 | B1 | — | Copper nano particle MD50 [average | — | — | — | — | 5 | 4 | 1 |
| | | | particle size: 50 nm] (manufactured by | | | | | | | |
| | | | Ishihara Sangyo Kaisha, Ltd.) | | | | | | | |
| 2 | B1 | A1 | Copper nano particle MD50 [average | N-Vinyl caprolactam | 50 | Dipropylene glycol diacrylate | 40 | 3 | 1 | 2 |
| | | | particle size: 50 nm] (manufactured by | (manufactured by | | (manufactured by Akcros | | | | |
| | | | Ishihara Sangyo Kaisha, Ltd.) | Sigma-Aldrich) | | Chemicals) | | | | |
| 3 | B1 | A1 | Copper nano particle MD50 [average | N-Vinyl caprolactam | 50 | Dipropylene glycol diacrylate | 40 | 4 | 1 | — |
| | | | particle size: 50 nm] (manufactured by | (manufactured by | | (manufactured by Akcros | | | | |
| | | | Ishihara Sangyo Kaisha, Ltd.) | Sigma-Aldrich) | | Chemicals) | | | | |

In Examples 1 to 12, the adhesion to the base material, the conductivity, and the pattern shape are good; it is exhibited that the conductive patterns having a gradient functional structure fabricated by various inkjet methods A (image formation mixing method) and B (ink mixing method) are effective from the standpoint of practical use; and there is no difference in the effect between the two kinds of inkjet methods, so that it is possible to form a conductive pattern having sufficient functions by any of these methods. In addition, though there was not substantially found a difference in performances among the types of monomers, so far as the adhesion is concerned, the inks containing N-vinyl lactam exhibited good performances as compared with the inks containing other curable monomer. As to the present phenomenon, it may be considered that in addition to the fact that the adhesion of the curable monomer to the base material is good, an aggregation within the layer is enhanced due to a coordination interaction with the metal particle, so that a firm layer is formed.

On the other hand, as seen in Comparative Example 1, in the case of using an ink containing only a metal particle used in the invention and forming a conductive pattern by means of usual inkjet image formation, the adhesion to the resin base material is not revealed because of the metal layer, and the separation easily occurs.

In addition, as seen in Comparative Example 2, in the case of mixing a metal ink and a curable ink to form a conductive pattern composed of a single layer without a composition gradient, a good pattern having sufficient adhesion to a base material and high conductivity is not obtained; because of a mixture of an organic material and a metal, sufficient electrical continuity is impaired due to insulation of the organic material; and wet and spreading properties as an ink onto a base material are not controlled, but the generation of bulge or the like becomes remarkable.

According to the fabrication of a gradient layer by means of coating as seen in Comparative Example 3, fine line patterning is originally impossible (hence, the pattern shape cannot be evaluated); and because of coating, when the lower layer was fully cured (thoroughly cured), the layer was weak due to interlaminar separation, and as a result, only a layer with poor adhesion was formed.

### Example 13

### Fabrication Of Metal Ink

- Metal ink A1 -

| | |
|---|---|
| Copper nano particle MD50 (average particle size: 50 nm, | 10 g |
| manufactured by Ishihara Sangyo Kaisha, Ltd.): | |
| Laurylamine (manufactured by Tokyo Chemical Industry | 3 g |
| Co., Ltd.): | |
| Cyclohexanone (manufactured by Wako Pure Chemical | 27 g |
| Industries, Ltd.): | |

The foregoing raw materials and 60 g of zirconia beads were charged into a 200-mL vessel and sealed, and the contents were dispersed for 30 minutes using a paint shaker dispersing machine (manufactured by Toyo Seiki Seisaku-sho, Ltd.). Thereafter, the resultant was filtered with a 2-μm filter to fabricate a metal ink A1.

### Fabrication of Resin Ink

- Resin ink B1 -

| | |
|---|---|
| Urethane oligomer UN-1225 Negami Chemical Industrial | 50 g |
| Co., Ltd.): | |
| Cyclohexanone (manufactured by Wako Pure Chemical | 450 g |
| Industries, Ltd.): | |

The foregoing raw materials were charged into a 2-liter vessel and stirred for 20 minutes while keeping a liquid temperature at not higher than 40° C. by a Silverson high-speed stirrer. Thereafter, the resultant was filtered with a 2-μm filter to fabricate a resin ink B 1.

### Fabrication of Conductive Pattern

On a transparent PET base material (thickness: 150 μm, manufactured by Fujifilm Corporation), a conductive pattern (line width: 100 μm) composed of a composition gradient layer having a thickness of 10 μm was formed by the following inkjet image formation method A and then evaluated with respect to adhesion of the conductive pattern to the base material, conductivity and pattern formation.

### —Inkjet Image Formation Method A—

The metal ink A1 and the resin ink B1 were respectively filled in the ink tank 1 and the ink tank 2 as shown in FIG. 3. The inks to be supplied into the inkjet head 1 and the inkjet head 2 are the metal ink A1 and the resin ink B1, respectively.

Firstly, ink droplets to be ejected from the inkjet head 2 were controlled so as to have a droplet amount of 10 pL and a droplet size of 30 μm, and the resin ink B1 was ejected from the inkjet head 2 in a nitrogen gas atmosphere. Here, the ink layer 1 was formed without ejecting the metal ink A1 from the inkjet head 1 (namely, a ratio (% by mass) of an ejection amount of the ink ejected from the inkjet head 2 to an ejection amount of the ink ejected from the inkjet head 1 is 100/0) and semi-dried upon drying at 80° C. for 30 seconds.

Subsequently, lamination and semi-drying were repeated by changing the ratio (% by mass) of an ejection amount of the ink ejected from the inkjet head 2 to an ejection amount of the ink ejected from the inkjet head 1 to 75/25 (ink layer 2), 50/50 (ink layer 3), 25/75 (ink layer 4), and 0/100 (ink layer 5), respectively, and finally, full drying (at 110° C. for 60 seconds) was performed to form a conductive pattern composed of the composition gradient layer.

Here, at the time of forming the ink layer 2, an ink droplet of the metal ink A1 to be ejected from the inkjet head 1 was adjusted so as to have a droplet amount of 5 pL and a droplet size of 20 μm, and an ink droplet of the resin ink B1 to be ejected from the inkjet head 2 was adjusted so as to have a droplet amount of 10 pL and a droplet size of 30 μm. At the time of forming the ink layer 3, an ink droplet of the metal ink A1 was adjusted so as to have a droplet amount of 10 pL and a droplet size of 30 μm, and an ink droplet of the resin ink B1 was adjusted so as to have a droplet amount of 10 pL and a droplet size of 30 μm. At the time of forming the ink layer 4, an ink droplet of the metal ink A1 was adjusted so as to have a droplet amount of 10 pL and a droplet size of 30 μm, and an ink droplet of the resin ink B1 was adjusted so as to have a droplet amount of 5 pL and a droplet size of 20 μm. At the time of forming the ink layer 5, an ink droplet of the metal ink A1 was adjusted so as to have a droplet amount of 10 pL and a droplet size of 30 μm. In addition, a thickness of each of the ink layers 1 to 5 after full drying was adjusted to 2 μm.

### Evaluation of Conductive Pattern

### <Adhesion>

The formed conductive layer was subjected to a cross hatch test (EN ISO2409). Evaluation criteria were made in conformity with ISO2409, and the results were shown by a point system of evaluation of from point 0 to point 5.

### <Conductivity>

The formed conductive layer was measured for a volume resistivity using Loresta MP MCP-T350 (manufactured by Mitsubishi Chemical Corporation) and the results thereof were evaluated by the following criteria.

4: Volume resistivity: Not more than 1×10⁻⁵ Ω·m

3: Volume resistivity: More than 1×10⁻⁵ Ω·m and not more than 1×10⁻⁴ Ω·m

2: Volume resistivity: More than 1×10⁻⁴ Ω·m and not more than 1×10⁻² Ω·m

1: Volume resistivity: More than 1×10⁻² Ω·m

### <Pattern Shape>

On a transparent PET base material (thickness: 150 μm, manufactured by Fujifilm Corporation), a conductive pattern composed of a composition gradient layer having a line width of 100 μm was subjected to image formation by means of inkjet, linearity of an image-formed straight line was visually evaluated, and evaluation was made by a boundary sample according to the following evaluation criteria.

4: The both widths of the line were a straight line, and a line width within 100 μm±5 μm was reproduced.

3: A zigzag remained in the both widths of the line, and a line width within 100 μm±10 μm was reproduced.

2: A zigzag remained remarkably in the both widths of the line, and a line width within 100 μm±20 μm was reproduced.

1: A zigzag remained remarkably in the both widths of the line, the line width was non-uniform, and bulge occurred partially.

The evaluation results of the conductive pattern formed in Example 13 are shown in the following Table 2.

### Example 14

As inks that is a mixture of the metal ink A1 and the resin ink B1 used in Example 13, an ink G1 (mixing ratio (% by mass) of A1/B1=25/75), an ink G2 (mixing ratio (% by mass) of A1/B1=50/50), and an ink G3 (mixing ratio (% by mass) of A1/B1=75/25) were fabricated. On a transparent PET base material (thickness: 150 μm, manufactured by Fujifilm Corporation), a conductive pattern composed of a composition gradient layer (line width: 100 μm) having a thickness of 10 μm was formed by the following inkjet image formation method B by using five print heads in which five kinds of the foregoing inks also including the inks A1 and B1 had been filled in order of B1 (lowermost layer), G1, G2, G3, and A1 (uppermost layer). By using the transparent PET base material having the present conductive pattern formed thereon, adhesion of the composition gradient layer to the base material, conductivity and pattern formation were evaluated. The results are shown in the following Table 2.

### —Inkjet Image Formation Method B—

The inks B1, G1, G2, G3 and A1 were respectively filled in the ink tanks 60-1 to 60-5 as shown in FIG. 7. The inks to be supplied into the inkjet heads 50-1 to 50-5 are the inks B1, G1, G2, G3 and A1, respectively.

Firstly, the ink B1 was ejected from the inkjet head 50-1 in a nitrogen gas atmosphere while controlling ink droplets to be ejected from the inkjet head so as to have a droplet amount of 10 pL and a droplet size of 30 μm.

The thus formed ink B1 layer was semi-dried upon drying at 80° C. for 30 seconds.

Subsequently, the ink G1 was similarly ejected from the inkjet head 50-2, and the ink G1 layer was laminated and semi-dried. This was also repeated with respect to the inks G2, G3 and A1, lamination and semi-drying were repeated, and finally, full drying (at 110° C. for 60 seconds) was performed to form a composition gradient layer.

Incidentally, a thickness of each of the ink layers B1, G1, G2, G3 and A1 after full drying was adjusted to 2 μm.

### Examples 15 to 23

Conductive patterns composed of a composition gradient layer (line width: 100 μm) having a thickness of 10 μm were formed in the same method as that in Example 13, except that the metal and the polymer or oligomer contained in the metal ink and the resin ink were respectively replaced by those described in the following Table 2, and then evaluated with respect to adhesion to the base material, conductivity, and pattern shape. The results are shown in the following Table 2.

### Comparative Example 4

On a transparent PET base material (thickness: 150 μm, manufactured by Fujifilm Corporation), a conductive pattern (line width: 100 μm) having a thickness of 10 μm, which was configured of only one layer, was formed using only the metal ink A1 used in Example 13 by means of inkjet image formation, and then evaluated with respect to adhesion to the base material, conductivity, and pattern shape. The results are shown in the following Table 2.

### Comparative Example 5

On a transparent PET base material (thickness: 150 μm, manufactured by Fujifilm Corporation), a conductive pattern (line width: 100 μm) having a thickness of 10 μm, which was configured of only one layer, was formed using a mixed ink E1 obtained by previously mixing the metal ink A1 and the resin ink B1 used in Example 13 (mixing ratio (mass ratio)=1/1) and well stirring the contents, by means of inkjet image formation, and then evaluated with respect to adhesion to the base material, conductivity, and pattern shape. The results are shown in the following Table 2.

TABLE 2

| | Type of | | | | | | |
|---|---|---|---|---|---|---|---|
| | ink | | Ink-constituting material | | | | |
| | Metal | Resin | Metal | Resin | Ad- | Conduct- | Pattern |
| | ink | ink | ink | ink | hesion | ivity | shape |
| Example | | | | | | | |
| No. | | | | | | | |
| 13 | A1 | B1 | Copper nano particle MD50 [average particle | Urethane oligomer UN-1225 (manufactured | 0 | 4 | 4 |
| | | | size: 50 nm] (manufactured by Ishihara Sangyo | by Negami Chemical Industrial Co., Ltd.) | | | |
| | | | Kaisha, Ltd.) | | | | |
| 14 | A1 | B1 | Copper nano particle MD50 [average particle | Urethane oligomer UN-1225 (manufactured | 0 | 4 | 4 |
| | | | size: 50 nm] (manufactured by Ishihara Sangyo | by Negami Chemical Industrial Co., Ltd.) | | | |
| | | | Kaisha, Ltd.) | | | | |
| 15 | A1 | B2 | Copper nano particle MD50 [average particle | Urethane oligomer CN962 (manufactured | 0 | 4 | 4 |
| | | | size: 50 nm] (manufactured by Ishihara Sangyo | by Sartmer Company Inc.) | | | |
| | | | Kaisha, Ltd.) | | | | |
| 16 | A1 | B3 | Copper nano particle MD50 [average particle | Urethane oligomer CN965 (manufactured | 0 | 4 | 4 |
| | | | size: 50 nm] (manufactured by Ishihara Sangyo | by Sartmer Company Inc.) | | | |
| | | | Kaisha, Ltd.) | | | | |
| 17 | A1 | B4 | Copper nano particle MD50 [average particle | Polybutyl methacrylate (manufactured by | 2 | 4 | 4 |
| | | | size: 50 nm] (manufactured by Ishihara Sangyo | Sigma-Aldrich) | | | |
| | | | Kaisha, Ltd.) | | | | |
| 18 | A2 | B2 | Copper nano particle MD200 [average particle | Urethane oligomer CN962 (manufactured | 0 | 4 | 4 |
| | | | size: 200 nm] (manufactured by Ishihara | by Sartmer Company Inc.) | | | |
| | | | Sangyo Kaisha, Ltd.) | | | | |
| 19 | A2 | B4 | Copper nano particle MD200 [average particle | Polybutyl methacrylate (manufactured by | 2 | 4 | 4 |
| | | | size: 200 nm] (manufactured by Ishihara | Sigma-Aldrich) | | | |
| | | | Sangyo Kaisha, Ltd.) | | | | |
| 20 | A3 | B1 | Silver nano particle NPS-J [average particle | Urethane oligomer UN-1225 (manufactured | 0 | 4 | 4 |
| | | | size: 5 nm] (manufactured by Harima | by Negami Chemical Industrial Co., Ltd.) | | | |
| | | | Chemicals, Inc.) | | | | |
| 21 | A3 | B4 | Silver nano particle NPS-J [average particle | Polybutyl methacrylate (manufactured by | 2 | 4 | 4 |
| | | | size: 5 nm] (manufactured by Harima | Sigma-Aldrich) | | | |
| | | | Chemicals, Inc.) | | | | |
| 22 | A3 | B2 | Silver nano particle NPS-J [average particle | Urethane oligomer CN962 (manufactured | 0 | 4 | 4 |
| | | | size: 5 nm] (manufactured by Harima | by Sartmer Company Inc.) | | | |
| | | | Chemicals. Inc.) | | | | |
| 23 | A1 | B8 | Copper nano particle MD50 [average particle | Urethane oligomer CN965 (manufactured | 0 | 4 | 4 |
| | | | size: 50 mm] (manufactured by Ishihara | by Sartmer Company Inc.)/polybutyl | | | |
| | | | Sangyo Kaisha, Ltd.) | methacrylate (manufactured by | | | |
| | | | | Sigma-Aldrich) = 20/80 (% by mass) | | | |
| Compar- | | | | | | | |
| ative | | | | | | | |
| Example | | | | | | | |
| No. | | | | | | | |
| 4 | A1 | — | Copper nano particle MD50 [average particle | — | 5 | 4 | 1 |
| | | | size: 50 nm] (manufactured by Ishihara Sangyo | | | | |
| | | | Kaisha, Ltd.) | | | | |
| 5 | A1 | B1 | Copper nano particle MD50 [average particle | Urethane oligomer UN-1225 (manufactured | 3 | 1 | 2 |
| | | | size: 50 nm] (manufactured by Ishihara | by Negami Chemical Industrial Co., Ltd.) | | | |
| | | | Sangyo Kaisha, Ltd.) | | | | |

In Examples 13 to 23, the adhesion to the base material, the conductivity, and the pattern shape are good; it is exhibited that the conductive patterns having a gradient functional structure fabricated by various inkjet methods A (image formation mixing method) and B (ink mixing method) are effective from the standpoint of practical use; and there is no difference in the effect between the two kinds of inkjet methods, so that it is possible to form a conductive pattern having sufficient functions by any of these methods.

In addition, on review of a difference in performances among the inks containing a different resin from each other, with respect to the adhesion, the case of using an ink containing a urethane resin exhibited good performances as compared with the case of using an ink containing other resin. As to the present phenomenon, it may be considered that in addition to the fact that the adhesion of the urethane resin to the base material is good, an aggregation within the layer is enhanced due to a coordination interaction between a urethane bond and a metal particle, so that a firm layer is formed.

On the other hand, as seen in Comparative Example 4, in the case of using an ink containing only a metal particle to form a conductive pattern, the adhesion between the metal layer and the resin base material is not revealed, and the conductive pattern easily separates.

In addition, as seen in Comparative Example 2, in the case of mixing a metal ink and a resin ink to form a conductive pattern composed of a single layer without a composition gradient, a good pattern having sufficient adhesion to a base material and high conductivity was not revealed. Since the subject conductive pattern is formed of a mixture of an organic material and a metal, not only sufficient electrical continuity is impaired due to insulation of the organic material, but wet and spreading properties as an ink onto a base material are not controlled. Thus, it may be considered that the generation of bulge or the like became remarkable.

This application is based on Japanese Patent application JP 2011-179845, filed on Aug. 19, 2011 and Japanese Patent application JP 2011-179998, filed on Aug. 19, 2011, the entire contents of which are hereby incorporated by reference, the same as if fully set forth herein.

1. A forming method of a conductive pattern comprising a base material and a pattern of a composition gradient layer in which the composition continuously changes from a metal to a resin in a thickness direction from the farthest side to the base material toward the nearest side to the base material, which comprises
ejecting at least two kinds of ink compositions of an ink composition containing a metal and an ink composition containing a compound capable of being cured with active energy ray, or a polymer or oligomer, onto the base material by an inkjet method to fabricate the composition gradient layer.

2. The forming method of a conductive pattern according to claim 1, wherein
at least an ink composition containing a metal and an ink composition containing a compound capable of being cured with active energy ray are used as the at least two kinds of ink compositions, and
the inkjet method uses at least a first inkjet head and a second inkjet head, and wherein the method comprises:
a step of supplying a first ink containing the ink composition containing a metal into the first inkjet head;
a step of supplying a second ink containing the ink composition containing a compound capable of being cured with active energy ray into the second inkjet head;
a control step of determining a ratio of an amount of the first ink ejected from the first inkjet head to an amount of the second ink ejected from the second inkjet head;
a forming step of ejecting the first ink or the second ink from at least one of the first inkjet head and the second inkjet head according to the determined ratio, thereby forming one layer; and
a laminating step of repeating the forming step to laminate a plurality of the layers on the base material, thereby obtaining the composition gradient layer, wherein
in the control step, the ratio is determined such that a ratio of the first ink becomes large, whereas a ratio of the second ink becomes small, in a thickness direction of the plurality of the layers from the near side to the base material toward the far side to the base material.

3. The forming method of a conductive pattern according to claim 2, wherein the second ink contains a compound having an unsaturated double bond, as the compound capable of being cured with active energy ray, and a polymerization initiator.

4. The forming method of a conductive pattern according to claim 3, wherein the compound having the unsaturated double bond is N-vinyl caprolactam.

5. The forming method of a conductive pattern according to claim 2, wherein in the forming step, an ink amount of droplets ejected from the first and second inkjet heads is from 0.3 to 100 pL.

6. The forming method of a conductive pattern according to claim 2, wherein in the forming step, a droplet size of droplets ejected from the first and second inkjet heads is from 1 to 300 μm.

7. The forming method of a conductive pattern according to claim 1, wherein
at least an ink composition containing a metal and an ink composition containing a compound capable of being cured with active energy ray are used as the at least two kinds of ink compositions, and
the inkjet method uses a plurality of inkjet heads, and wherein the method comprises:
a step of supplying a plurality of mixed inks which are a mixture of a first ink containing the ink composition containing a metal and a second ink containing the ink composition containing a compound capable of being cured with active energy ray, and which are different in a mixing ratio from each other, into the plurality of inkjet heads, respectively;
a selecting step of successively selecting one inkjet head from the plurality of inkjet heads in decreasing order of a ratio of the second ink contained in the mixed ink supplied into the inkjet head;
a forming step of ejecting the mixed ink from the selected inkjet head, thereby forming one layer; and
a laminating step of repeating the forming step to laminate a plurality of the layers on the base material, thereby obtaining the composition gradient layer.

8. The forming method of a conductive pattern according to claim 7, wherein the second ink contains a compound having an unsaturated double bond, as the compound capable of being cured with active energy ray, and a polymerization initiator.

9. The forming method of a conductive pattern according to claim 8, wherein the compound having the unsaturated double bond is N-vinyl caprolactam.

10. The forming method of a conductive pattern according to claim 7, wherein in the forming step, an ink amount of droplets ejected from the first and second inkjet heads is from 0.5 to 150 pL.

11. The forming method of a conductive pattern according to claim 7, wherein in the forming step, a droplet size of droplets ejected from the first and second inkjet heads is from 2 to 450 μm.

12. The forming method of a conductive pattern according to claim 1, wherein
at least an ink composition containing a metal and an ink composition containing a polymer or oligomer are used as the at least two kinds of ink compositions, and
the inkjet method uses at least a first inkjet head and a second inkjet head, and wherein the method comprises:
a step of supplying a first ink containing the ink composition containing a metal into the first inkjet head;
a step of supplying a second ink containing the ink composition containing a polymer or oligomer into the second inkjet head;
a control step of determining a ratio of an amount of the first ink ejected from the first inkjet head to an amount of the second ink ejected from the second inkjet head;
a forming step of ejecting the first ink or the second ink from at least one of the first inkjet head and the second inkjet head according to the determined ratio, thereby forming one layer; and
a laminating step of repeating the forming step to laminate a plurality of the layers on the base material, thereby obtaining the composition gradient layer, wherein
in the control step, the ratio is determined such that a ratio of the first ink becomes large, whereas a ratio of the second ink becomes small, in a thickness direction of the plurality of the layers from the near side to the base material toward the far side to the base material.

13. The forming method of a conductive pattern according to claim 12, wherein the polymer or oligomer is a urethane polymer or oligomer.

14. The forming method of a conductive pattern according to claim 13, wherein the urethane polymer or oligomer has a repeating unit represented by the following general formula (1): 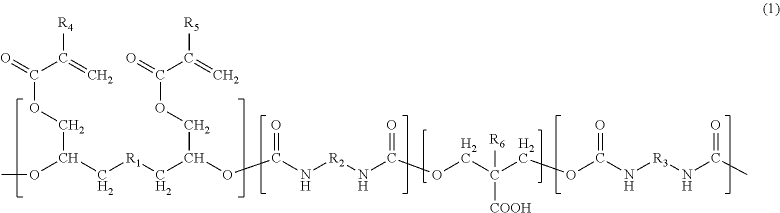
wherein each of R₁ to R₃ independently represents an alkylene group, an arylene group or a biarylene group; and each of R₄ to R₆ independently represents a hydrogen atom, an alkyl group, an aryl group or a heteroaryl group.

15. The forming method of a conductive pattern according to claim 12, wherein in the forming step, an ink amount of droplets ejected from the first and second inkjet heads is from 0.3 to 100 pL.

16. The forming method of a conductive pattern according to claim 12, wherein in the forming step, a droplet size of droplets ejected from the first and second inkjet heads is from 1 to 300 μm.

17. The forming method of a conductive pattern according to claim 1, wherein
at least an ink composition containing a metal and an ink composition containing a polymer or oligomer are used as the at least two kinds of ink compositions, and
the inkjet method uses a plurality of inkjet heads, and wherein the method comprises:
a step of supplying a plurality of mixed inks which are a mixture of a first ink containing the ink composition containing a metal and a second ink containing the ink composition containing a polymer or oligomer, and which are different in a mixing ratio from each other, into the plurality of inkjet heads, respectively;
a selecting step of successively selecting one inkjet head from the plurality of inkjet heads in decreasing order of a ratio of the second ink contained in the mixed ink supplied into the inkjet head;
a forming step of ejecting the mixed ink from the selected inkjet head, thereby forming one layer; and
a laminating step of repeating the forming step to laminate a plurality of the layers on the base material, thereby obtaining the composition gradient layer.

18. The forming method of a conductive pattern according to claim 17, wherein the polymer or oligomer is a urethane polymer or oligomer.
